(19) United States
(12) Patent Application Publication
(10) Pub. No.: US 2019/0358904 A1
(43) Pub. Date: Nov. 28, 2019

(54) FILAMENT AND METHOD OF MANUFACTURING THE SAME

(71) Applicant: HOTTY POLYMER CO., LTD., Tokyo (JP)

(72) Inventors: Hidetoshi Hotta, Tokyo (JP); Kazuo Aoki, Tokyo (JP); Fumio Tanabe, Tokyo (JP)

(21) Appl. No.: 16/485,202

(22) PCT Filed: May 22, 2017
(86) PCT No.: PCT/JP2017/019093

§ 371 Date: Aug. 12, 2019

(30) Foreign Application Priority Data
Feb. 14, 2017 (JP) 2017-025403

(51) Int. Cl. B29C 64/314; B29C 64/118

(52) U.S. Cl. CPC B29C 64/314; B33Y 70/00; B29C 64/118

(57) ABSTRACT

A filament which can give an arbitrary hardness to a three-dimensional molded object and is not bent in a conveying process and a method of manufacturing the same are provided. In the present invention, a filament used as a material of a printed matter printed by a three-dimensional printing device using a fused deposition modeling method (FDM) is configured to contain a polylactic acid resin and a thermoplastic elastomer.

### TECHNICAL FIELD

The present invention relates to a filament used as a material for a printed matter printed by a three-dimensional printing device using a fused deposition modeling method (FDM) and a method of manufacturing the same.

### BACKGROUND ART

In the past, a three-dimensional printing device is used to create a three-dimensional molded object such as a sample or a jig. The three-dimensional printing device is also called a 3D printer and can create a three-dimensional molded object by a material such as a resin according to three-dimensional drawing data imported on a computer.

There are various methods of forming three-dimensional molded objects, and one of the methods is a fused deposition modeling method (FDM). In the fused deposition modeling method (FDM), a raw filament such as a thermoplastic resin is discharged from a nozzle while being heated and fused by a heater, a first layer of a three-dimensional molded object is formed by operating the nozzle in, for example, a planar direction, and a second layer and a third layer are sequentially laminated on the upper surface of the first layer to obtain the three-dimensional molded object.

A three-dimensional printing device of the fused deposition modeling method (FDM) is lower in price than a three-dimensional printing device obtained by a modeling method using a laser and powder sintering and is widely prevalent.

In such a three-dimensional printing device of the conventional fused deposition modeling method (FDM), for example, a three-dimensional molded object is printed by using a filament made of a resin having a relatively low plasticizing temperature which is a hard resin having a high Shore A hardness such as ABS resin or a polylactic acid (PLA) resin.

If printing can be performed by using a soft filament having a Shore A hardness lower than that of a hard filament as a raw filament, a molded object such as a part requiring flexibility can be manufactured, and usability is further improved.

However, when a soft filament is used as a raw filament for a three-dimensional printing device of a general fused deposition modeling method (FDM), since the filament itself has not rigidity, the filament is bent in a conveying process to a head or in the head and cannot be conveyed, i.e., a so-called jamming phenomenon disadvantageously occurs.

In the past, there is a three-dimensional printing device of a fused deposition modeling method (FDM) which can use a soft filament. However, since this device is dedicated to a soft filament and has no versatility and is expensive, the device is not readily used.

In a three-dimensional printing device, a supplied filament is nipped by feeding rollers and conveyed to a discharge head, thermally fused by a head heater, and discharged from a nozzle part to form a three-dimensional molded object. When the sectional shape of the filament has an elliptic shape or another eccentric shape, nipping force or the like acting on a contact point to the roller becomes strong or weak to cause defective conveyance in which the filament is bent or fed.

Thus, the filament preferably has a section which is perfectly circular over a wide range in the longitudinal direction of the section.

In addition, the defective conveyance of the filament appears as uneven discharge or a discharge error from the head nozzle, and is related to reproduction accuracy of three-dimensional drawing data imported on a computer.

According to the technical requirements for the filament, an additional function (for example, a flavor or a dust-proof effect) exceeding a three-dimensional molding function is difficult to be added to a filament serving as a material to increase an added value and to improve the usability.

An additive agent (to be referred to as a functional agent) giving the additive function is a foreign matter which is used for purposes other than original intent of a filament or the like made of a polylactic acid resin simply developed for three-dimensional molding.

As a result, the filament having the additional function has a sectional shape uneven more than a filament (made of only a polylactic acid resin, for example) which has no additional function, and defective conveyance or low reproduction accuracy may occur.

Thus, a filament which can be preferably fed in a three-dimensional printing device and can give a function other than a shape, for example, a flavor to a three-dimensional molded object is historically requested. [Conventional Art Literature]

### PATENT LITERATURE

[Patent Literature 1] Published Japanese Translation of a PCT application No. 2016-501137

### SUMMARY OF THE INVENTION

### Problem to be Solved by the Invention

The present invention has been made in consideration of the above circumstances and has as its object to provide a filament which is not bent in conveying and a method of manufacturing the same.

In addition, the present invention has been made in consideration of the above circumstances and has as its object to provide a filament which can be preferably fed in a three-dimensional printing device and can give a function other than a shape to a three-dimensional molded object.

### Means for Solving the Problem

### Explanation of Terms

A “polylactic acid (PLA) resin” (will be used in the following description) is a synthetic resin produced by polymerizing a lactic acid by an ester bond. The plasticizing temperature is 170° C. and the Shore A hardness is 100 or more.

The Shore A hardness is a hardness measured by using durometer in a method regulated in JIS K 7215 (plastic) or JIS K 6253 (vulcanized rubber and thermoplastic rubber). Definitions of softness or hardness in a resin or a rubber are various. Here, a resin or rubber having a Shore A hardness of 95 or more is called a hard resin or rubber, and a resin or rubber having a Shore A hardness of 95 or less is called a soft resin or rubber.

An “thermoplastic elastomer” is a concept including an olefinic elastomer and a styrene elastomer.

The olefinic elastomer is a thermoplastic elastomer obtained by microdispersing polyethylene-polypropylene rubber (EPDM, EDM) into polypropylene and is a synthetic resin which has flexibility and restorableness such as rubber at room temperature, has a large friction coefficient, and can be shaped like an ordinary resin.

The styrene elastomer is a thermoplastic elastomer obtained by block-copolymerizing polystyrene and polyethylene-polybutylene, and exhibits the characteristics of an elastic object because the domain of polystyrene becomes a physical crosslinked point to fulfill a role corresponding to a crosslinked point of a cross-linked rubber. On the other hand, when the temperature becomes a temperature of 140 to 230° C. at which ejection or extrusion can be performed, both a polystyrene part and a polyethylene-polybutylene part are fused to exhibit a fluid characteristic of a thermoplastic resin.

An “olefinic resin” is a concept including an olefinic elastomer, and a “styrene resin” is a concept including a styrene elastomer.

A “plasticizer” is a collective term of additive chemicals which is added to a thermoplastic synthetic resin to improve flexibility and whether resistance.

“Mineral oil” is also called liquid petroleum and is a collective term of mixtures such as petroleum (crude), natural gas, or mineral coal also containing a carbon hydride compound or an impurity derived from natural products. In general, mineral oil is classified into any one of paraffinic oil, naphthenic oil, or higher fatty acid.

The invention described in claim 1 provides a filament which is used as a material of a printed matter printed by a three-dimensional printing device using a fused deposition modeling method (FDM) and contains a polylactic acid resin and a thermoplastic elastomer.

In the invention described in claim 2, the thermoplastic elastomer contains a styrene resin and a mineral-oil-based plasticizer.

In the invention described in claim 3, the thermoplastic elastomer contains an olefinic resin and a mineral-oil-based plasticizer.

In the invention described in claim 4, the filament contains the polylactic acid resin and the thermoplastic elastomer at an arbitrary ratio ranging from 10 parts by weight:1 part by weight to 1 part by weight to 10 parts by weight.

In the invention described in claim 5, the thermoplastic elastomer contains an olefinic resin and a mineral-oil-based plasticizer at an arbitrary ratio ranging from a mixing weight ratio of 10:90 to a mixing weight ratio of 70:30.

The invention described in claim 6 provides a method of manufacturing a filament used as a material of a printed matter printed by a three-dimensional printing device using a fused deposition modeling method (FDM) wherein a total of 100% by weight of a polylactic acid resin and a thermoplastic elastomer are mixed and fused by heating to manufacture a filament by extrusion.

In the invention described in claim 7, the thermoplastic elastomer contains a styrene resin and a mineral-oil-based plasticizer.

In the invention described in claim 8, the thermoplastic elastomer contains an olefinic resin and a mineral-oil-based plasticizer.

The invention described in claim 9 provides a method of manufacturing a filament used as a material of a printed matter printed by a three-dimensional printing device using a fused deposition modeling method (FDM) including the mixing step of mixing a polylactic acid resin and a thermoplastic elastomer with each other to produce a mixture and the molding step of molding the obtained mixture into a filament by extrusion.

In the invention described in claim 10, in the mixing step, the polylactic acid resin and the thermoplastic elastomer are mixed with each other at a ratio of 10 parts by weight:1 part by weight to 1 part by weight to 10 parts by weight.

The invention described in claim 11 includes, before the mixing step, the thermoplastic elastomer producing step of adjusting a mixing weight ratio of an olefinic resin and a mineral-oil-based plasticizer to a ratio ranging from 10:90 to 70:30 to produce a thermoplastic elastomer.

In the invention described in claim 12 provides a filament used in a three-dimensional printing device performing three-dimensional molding by using a fused deposition modeling method (FDM) and serving as a material of a three-dimensional molded object wherein the filament contains a polylactic acid resin and a thermoplastic elastomer at an arbitrary ratio ranging from 85% by weight:15% by weight to 1% by weight:99% by weight.

In the invention described in claim 13, the filament contains the polylactic acid resin and the olefinic resin at an arbitrary ratio ranging from 60% by weight:40% by weight to 30% by weight:70% by weight.

In the invention described in claim 14, the filament contains the polylactic acid resin and the styrene resin at an arbitrary ratio ranging from 60% by weight:40% by weight to 30% by weight:70% by weight.

In the invention described in claim 15, the thermoplastic elastomer contains a mineral-oil-based plasticizer at a ratio of 40% by weight to 70% by weight.

In the invention described in claim 16, a filament is obtained by mixing a mixture of the polylactic acid resin and the thermoplastic elastomer with a functional agent giving characteristics other than a shape to the three-dimensional molded object.

In the invention described in claim 17, the functional agent is mixed at an arbitrary ratio ranging from 20% by weight or less.

In the invention described in claim 18, the functional agent includes at least one of botanical essential oil, lubricant, aromatic ester, and paraben.

### [Advantages]

According to the inventions described in claims 1 to 3, a filament in which a hardness can be continuously changed by a ratio of a polylactic acid resin having a high hardness and a thermoplastic elastomer between the hardness of the polylactic acid resin and the hardness of the thermoplastic elastomer can be achieved. Here, the plasticizing temperature of the polylactic acid resin and the plasticizing temperature of the thermoplastic elastomer are almost equal to each other, and an almost constant plasticizing temperature is exhibited regardless of a ratio of the polylactic acid resin and the thermoplastic elastomer. Thus, in the filament according to the present invention, the polylactic acid resin and the thermoplastic elastomer can be simultaneously uniformly thermally fused.

Thus, according to the inventions described in claims 1 to 3, a filament which can give an arbitrary hardness to a three-dimensional molded object and is not bent in conveying can be provided.

According to the inventions described in claims 4 and 5, a filament which can give flexibility to a three-dimensional molded object and is not bent in conveying can be provided.

In the methods of manufacturing filaments described in claims 6 to 8, since a filament obtained by mixing a polylactic acid resin having a high hardness and a thermoplastic elastomer having a low hardness at an arbitrary ratio is manufactured by extrusion, a filament having an arbitrary hardness between the hardness of the polylactic acid resin and the hardness of the thermoplastic elastomer by the ratio of the polylactic acid resin and the thermoplastic elastomer can be manufactured.

In addition, in the methods of manufacturing filaments described in claims 6 to 8, since the plasticizing temperature of the polylactic acid resin and the plasticizing temperature of the thermoplastic elastomer are almost equal to each other, regardless of the ratio of the polylactic acid resin and the thermoplastic elastomer, a filament exhibiting an almost constant plasticizing temperature can be manufactured.

Thus, according to the inventions described in claims 6 to 8, a method of manufacturing a filament which can gives an arbitrary hardness to a three-dimensional molded object and has a hardness at which the filament is not bent in conveying can be provided.

According to the inventions described in claims 9 and 10, a method of manufacturing a filament which can give flexibility to a three-dimensional molded object and is not bent in conveying can be provided.

In the methods of manufacturing filaments described in claims 6 to 11, since the filament is manufactured by extrusion, the molded filament has such anisotropy that the filament is not easily deformed in an extrusion direction and is easily deformed in a direction orthogonal to the extrusion direction.

Thus, when a filament molded by the methods of manufacturing filaments described in claims 6 to 11 is used as a raw filament for a three-dimensional printing device of a fused deposition modeling method (FDM), since a conveying direction to the head is the same as the extrusion direction of the filament, the filament has rigidity in the conveying direction to the head.

As a result, a so-called jamming phenomenon in which the filament is bent in a conveying process to the head or in the head and cannot be conveyed can be prevented from occurring.

In addition, when the filament is generally conveyed in the three-dimensional printing device, the filament is drawn and conveyed while being nipped by a drive gear having grooves and a roller.

At this time, when the filament molded by the methods of manufacturing filaments described in claims 6 to 11 is used as a raw filament for a three-dimensional printing device of a fused deposition modeling method (FDM), when the filament is nipped by the drive gear and the roller, the filament is strongly pressed against the grooves of the drive gear. However, since the pressing direction is a direction orthogonal to the extrusion direction of the filament, the filament is easily deformed as described above.

As a result, the filament is deformed depending on the grooves of the drive gear and meshed with the grooves of the drive gears to prevent the filament from being slipped.

Therefore, the filament can be reliably conveyed by the drive gear, and a three-dimensional molded object can be stably printed over a long period of time.

The filaments described in claims 12 to 15 contains polylactic acid and a thermoplastic elastomer at a predetermined ratio to compare the filament with a filament made of polylactic acid, and the sectional shape of the filament is easily suppressed from being uneven.

As a result, the sectional shape of the filament can be approximated to a perfect circle, nipping force acting on a contact point between the filament and the roller nipping and feeding the filament in the three-dimensional printing device becomes stable, and defective conveyance decreases. In addition, since the defective conveyance of the filament decreases, uneven discharge from a nozzle of a head part decreases to make it possible to improve reproduction accuracy of three-dimensional drawing data imported on a computer.

When polylactic acid and a thermoplastic elastomer are combined to each other at a weight ratio, a filament has a sectional shape which can be easily approximated to a perfect circle even though, for example, a functional agent such as SROPE (Registered Trade Mark) is contained in the filament can be achieved.

Thus, a filament which can be easily fed in the three-dimensional printing device and can give a function other than a shape to a three-dimensional molded object can be provided.

The filaments described in claims 16 and 17 can exert the effect in claim 12 and give characteristics other than a shape to a three-dimensional molded object, and the use value of the three-dimensional molded object is improved.

Since the SROPE (Registered Trade Mark) has active constituents being in an emulsion structure, in comparison with a functional agent having active constituents being in no emulsion structure, the SROPE moderately emits the active constituents.

In the filament described in claim 18 can give an effect such as aroma, dust proof, insect proof, mildew proof, or antibacterial activity to a three-dimensional molded object.

### BRIEF DESCRIPTION OF THE DRAWINGS

FIG. 1 is a graph showing a relationship between a content and a Shore A hardness of a thermoplastic elastomer when a total of 100% by weight of a polylactic acid resin and a thermoplastic elastomer are mixed with each other in a filament according to a first embodiment of the present invention.

FIG. 2A is a graph showing a relationship between an elongation and a tensile strength in a sheet sample extruded on the same conditions as those in the filament according to the first embodiment of the present invention, and FIG. 2B is a graph obtained by extending a range in which the elongation ranges from 0% to 200% in the graph in FIG. 2A.

FIG. 3 is a plan view of the sheet sample used in measurements in FIGS. 2A and 2B.

FIG. 4A is a perspective view of a sheet sample extruded on the same conditions as those of the filament according to the first embodiment of the present invention, FIG. 4B is a vertical sectional view obtained by observing the sheet sample in FIG. 4A by a scanning electron microscope,

FIG. 4C is a pattern diagram of FIG. 4B, FIG. 4D is a flowing-direction sectional view obtained by observing the sheet sample in FIG. 4A by a scanning electron microscope, and FIG. 4E is a pattern diagram of FIG. 4D.

FIG. 5 is a diagram showing a filament conveying mechanism in a head part of a three-dimensional printing device using a filament according to a second embodiment of the present invention.

FIGS. 6A and 6B are explanatory diagrams of a section roundness measurement of a filament according to a third embodiment of the present invention, in which FIG. 6A is a diagram showing a measuring device and FIG. 6B is a diagram showing a measuring method.

FIG. 7 is a diagram showing a result of a section roundness measurement of Comparative Example 1 for the filament according to the third embodiment of the present invention.

FIG. 8 is a diagram showing a result of a section roundness measurement of Comparative Example 2 for the filament according to the third embodiment of the present invention.

FIG. 9 is a diagram showing a result of a section roundness measurement of Comparative Example 3 for the filament according to the third embodiment of the present invention.

FIG. 10 is a diagram showing a result of a section roundness measurement of Example 1 for the filament according to the third embodiment of the present invention.

FIG. 11 is a diagram showing a result of a section roundness measurement of Example 2 for the filament according to the third embodiment of the present invention.

FIG. 12 is a diagram showing a result of a section roundness measurement of Example 3 for the filament according to the third embodiment of the present invention.

FIG. 13 is a diagram showing a result of a section roundness measurement of Example 4 for the filament according to the third embodiment of the present invention.

FIG. 14 is a diagram showing a result of a section roundness measurement of Example 5 for the filament according to the third embodiment of the present invention.

FIG. 15 is a diagram showing a result of a section roundness measurement of Example 6 for the filament according to the third embodiment of the present invention.

FIG. 16 is a diagram showing a result of a section roundness measurement of Example 7 for the filament according to the third embodiment of the present invention.

FIG. 17 is a diagram showing a result of a section roundness measurement of Example 8 for the filament according to the third embodiment of the present invention.

FIG. 18 is a diagram showing a result of a section roundness measurement of Example 9 for the filament according to the third embodiment of the present invention.

FIG. 19 is a diagram showing a result of a section roundness measurement of Example 10 for the filament according to the third embodiment of the present invention.

FIG. 20 is a diagram obtained by collecting the results of Comparative Example 1 to Comparative Example 3 and Example 1 to Example 10 in the third embodiment of the present invention.

### MODES FOR CARRYING OUT THE INVENTION

### First Embodiment

A filament and a method of manufacturing a filament according to the present invention will be described in detail on the basis of a first embodiment and examples.

### [Steps in Manufacturing Filament]

A filament according to the embodiment is manufactured by an ordinary extrusion machine.

More specifically, a 65ϕ extruder is used. As cylinder temperatures, 150 to 180° C. at a dice, 160 to 200° C. at a measuring part, 160 to 200° C. at a compressing part, 150 to 180° C. at a supply part.

A limit temperature is 240° C., a temperature of cooling water in a cooling tank ranges from 8 to 15° C., a die-sizer distance ranges from 2 to 5 cm, a draw down ratio ranges from 0.87 to 0.92, and a dry vacuum scheme is used as a die-sizing scheme.

In the filament according to the embodiment, after a total of 100% by weight of a pellet of a polylactic acid resin (A) and a pellet of a thermoplastic elastomer (B) are mixed with each other, the mixed pellet is put in an inlet of an extrusion machine, and a screw is rotated while being heated to fuse and feed the resin. The resin is extruded from a mold at the distal end and cooled and solidified in the cooling tank to manufacture a filament having a diameter of 1.75 mm.

### [Three-Dimensional Print Device]

A three-dimensional printing device according to the embodiment uses a fused deposition modeling method (FDM) and is configured by a data processing unit and a printing unit performing three-dimensional printing on the basis of a control signal supplied from the data processing unit.

The printing unit has a head part including a heater part and a nozzle part, and the head part has a drive gear supplying a raw filament to the nozzle part and a roller. Grooves are formed in the drive gear.

The three-dimensional printing device according to the embodiment is configured such that the raw filament is drawn while being nipped by the drive gear and the roller and conveyed to the head part and the filament fused by the heater part is discharged from the nozzle part to form a printed matter.

### [Raw Materials]

### A: Polylactic Acid Resin

A polylactic acid resin (A) in the embodiment has a purity of 70% or more (containing additives of 30% or less) by weight and a plasticizing temperature of 170° C. In particular, when the purity of the polylactic acid resin (A) 95% or more (containing additives of 5% or less), the characteristics of a filament (will be described later) and reproducibility of operational advantages become preferable.

In addition, in the polylactic acid resin (A) according to the present invention, a D-form content is preferably 1.0 mol % or less, or the D-form content is preferably 99.0 mol % or more. In particular, the content is preferably 0.1 to 0.6 mol % or 99.4 to 99.9 mol %.

When the D-form content falls within the range, since crystalline property is good, moldability is good (short molding cycle), and the heat resistance of the obtained molded object is improved.

### B: Thermoplastic Elastomer

A thermoplastic elastomer (B) according to the present invention contains a styrene resin (C) and a mineral-oil-based plasticizer (D). More specifically, a weight mixing ratio of a (C) component and a (D) component is given by (C) component/(D) component=25/75 to 30/70, and plasticizing temperature ranges 100 to 170° C.

### C: Styrene Resin

The styrene resin according to the present invention has a polystyrene block serving as a hard segment and conjugated diene polymer block serving as a soft segment, exhibits a vulcanized rubber-like physical property at a low temperature, and is heated and fused in a heating state to exhibit fluidity. As the styrene elastomer, styrene-butadiene-styrene block copolymer (SBS), styrene-isoprene-styrene block copolymer (SIS), styrene-ethylene/butylene-styrene block copolymer (SEBS), styrene-ethylene/propylene-styrene block copolymer (SEPS), partially hydrogenated styrene-ethylene/butylene-styrene block copolymer (partially hydrogenated SEBS), styrene.(ethylene-ethylene/propylene)-styrene block copolymer (SEEPS), or the like are exemplified. Desired styrene elastomers are SEBS and SEEPS. When the SEBS or the SEEPS is used, transparency is improved, and a good anti-slip property is obtained.

A mass average molecular weight of the styrene elastomer according to the present invention must ranges from 100000 to 200000. When the mass average molecular weight is less than 100000, mechanical strengths such as tensile strength, tensile elongation at break become poor. When the mass average molecular weight exceeds 200000, transparency becomes poor.

### D: Mineral-Oil-Based Plasticizer

In the present invention, as a plasticizer in a thermoplastic elastomer, a mineral-oil-based plasticizer is used. In the present invention, a mineral oil such as known paraffinic oil or naphthenic oil can be used. Of the mineral oils, a mineral oil which is refined petroleum paraffin hydrocarbon oil containing paraffin preferably compatible with styrene elastomer as a main component is preferably used.

### EXAMPLES

On the basis of the manufacturing method according to the present invention, a ratio of a polylactic acid resin (A) and a thermoplastic elastomer (B) was changed to manufacture filaments having different content percentages of the thermoplastic elastomer. The filament and the method of manufacturing a filament according to the embodiment are not limited to the following examples, and various changes of the invention can be effected without departing from the spirit and scope of the invention.

### Manufacturing Example 1 <Preparation of Filament (1)>

Filament (1) according to the embodiment is a filament manufactured by extrusion after a pellet of a polylactic acid resin (A) and a pellet of a thermoplastic elastomer (B) are mixed with each other at a ratio (content percentage of thermoplastic elastomer is 9.1%) of 10 parts by weight:1 part by weight.

### Manufacturing Example 2 <Manufacturing of Filament (2)>

Filament (2) according to the embodiment is a filament manufactured by extrusion after a pellet of a polylactic acid resin (A) and a pellet of a thermoplastic elastomer (B) are mixed with each other at a ratio (content percentage of thermoplastic elastomer is 33.3%) of 2 parts by weight:1 part by weight.

### Manufacturing Example 3 <Manufacturing of Filament (3)>

Filament (3) according to the embodiment is a filament manufactured by extrusion after a pellet of a polylactic acid resin (A) and a pellet of a thermoplastic elastomer (B) are mixed with each other at a ratio (content percentage of thermoplastic elastomer is 50%) of 1 part by weight:1 part by weight.

### Manufacturing Example 4 <Manufacturing of Filament (4)>

Filament (4) according to the embodiment is a filament manufactured by extrusion after a pellet of a polylactic acid resin (A) and a pellet of a thermoplastic elastomer (B) are mixed with each other at a ratio (content percentage of thermoplastic elastomer is 66.7%) of 1 part by weight:2 parts by weight.

### Manufacturing Example 5 <Manufacturing of Filament (5)>

Filament (5) according to the embodiment is a filament manufactured by extrusion after a pellet of a polylactic acid resin (A) and a pellet of a thermoplastic elastomer (B) are mixed with each other at a ratio (content percentage of thermoplastic elastomer is 90.9%) of 10 parts by weight:1 part by weight.

### Manufacturing Examples 6 to 10 <Manufacturing of Sheet Samples (1) to (5)>

Sheet samples (1) to (5) according to the embodiment are sheet samples manufactured by extrusion such that ratios of polylactic acid resins (A) and thermoplastic elastomers are equal to the radios of the filaments (1) to (5).

### Manufacturing Example 11 <Manufacturing of Sheet Sample (6)>

A sheet sample (6) according to the embodiment is a sheet sample manufactured by extrusion after a pellet of a polylactic acid resin (A) and a pellet of a thermoplastic elastomer (B) are mixed with each other at a ratio (content percentage of thermoplastic elastomer is 70%) of 3 parts by weight:7 parts by weight.

### Comparative Example 1 <Filament (6)>

A filament (6) according to the embodiment is a filament manufactured by extrusion using only a pellet of a polylactic acid resin (A) (content percentage of thermoplastic elastomer is 0%).

### Comparative Example 2 <Filament (7)>

A filament (7) according to the embodiment is a filament manufactured by extrusion using only a pellet of a thermoplastic elastomer (B) (content percentage of thermoplastic elastomer is 100%).

### Comparative Example 3 <Sheet Sample (7)>

A sheet sample (7) according to the embodiment is a sheet sample manufactured by extrusion using only a pellet of a polylactic acid resin (A) (content percentage of thermoplastic elastomer is 0%).

### Comparative Example 4 <Sheet Sample (8)>

A sheet sample (8) according to the embodiment is a filament manufactured by extrusion using only a pellet of a thermoplastic elastomer (B) (content percentage of thermoplastic elastomer is 100%).

### <Test>

### [Test Procedure]

### A Hardness (Sheet Samples (1) to (5), (7) to (8))

A Shore A hardness was measured based on JIS K 7215 (plastic). More specifically, a test piece has a thickness of 5 mm, and a sheet sample was manufactured by performing punching process from a sheet by extrusion. A test temperature is 23° C., and a test device is Shimazu durometer A available from SHIMAZU CORPORATION.

When the Shore A hardness is 20 or less, a Shore E hardness was measured by using Shimazu durometer E available from SHIMAZU CORPORATION on the basis of JIS K 6253 (vulcanized rubber and thermoplastic rubber). The other conditions are the same as those in the measurement for the Shore A hardness.

### B Tensile Strength and Elongation (Sheet Sample (6))

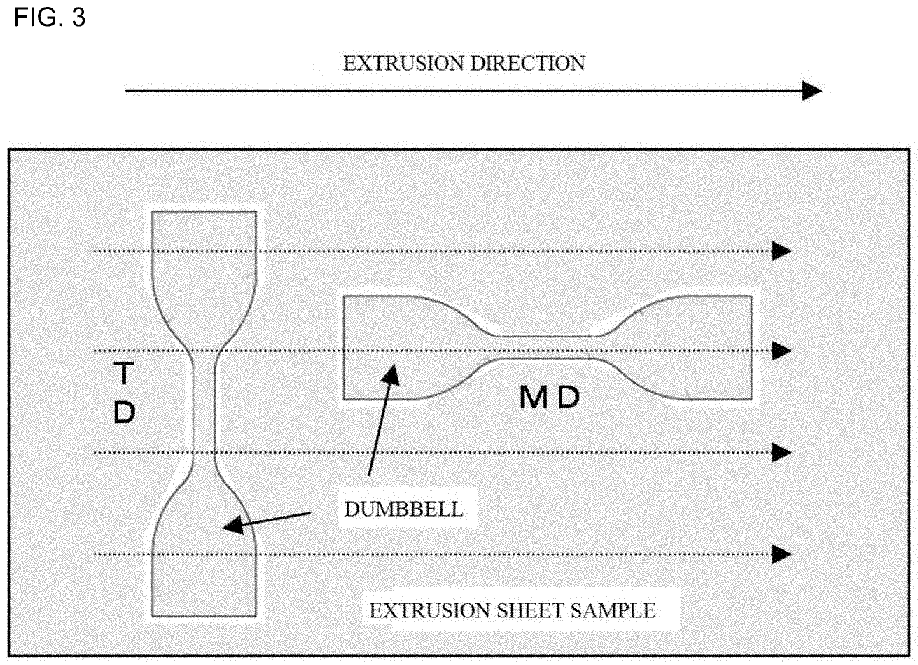

A measurement was performed based on JIS K 6251:2010. More specifically, a sample piece has a thickness of 2 mm, and a sheet sample was manufactured into a shape of dumbbell shape 3 by performing a punching process from an extrusion sheet (FIG. 3).

A tensile speed is 500 mm/min, a test temperature is 23, and a applied test machine strograph V10-D available from TOYO SEIKI Co., Ltd.

### C Microscope Image (Sheet Sample (6))

A measurement was performed by a scanning electron microscope (SEM).

### D Plasticizing Temperature (Filaments (1) to (7))

Differential thermal analyzer model 990 available from Du Pont was used, a measurement was performed at an increase at a rising temperature rate of 20° C./min, and a fusing peak was calculated. When a fusing temperature was not observed, a micro melting point measuring device (available from ANATEC YANACO CORPORATION) was used, and a temperature (softening point) at which a polymer was softened and begun to flow was set as a plasticizing temperature. The measurement was performed five times to calculate an average value.

### E Printing by a Three-Dimensional Printing Device (Filaments (1) to (2), (6))

Set temperature of heater part: 230° C.
Processing speed (head speed): 20 to 40 mm/s
Lamination height (printing pitch): 0.1 mm

Continuous printing time: A three-dimensional printed matter requiring about 30 min to 2 hours as printing duration was printed two or more times.

### [Test Result]

### A Hardness (Sheet Samples (1) to (5), (7) to (8))

Table 1 is a table representing relationships between content percentages and Shore A hardnesses of thermoplastic elastomer in the sheet samples (1) to (5) and (7) to (8) formed by the same extrusion as that in the filaments according to the embodiment.

TABLE 1

| | PLA · thermoplastic | |
|---|---|---|
| Sample | elastomer ratio | Hardness |
| Sheet sample (7) | Only PLA | Shore A 100 or more |
| Sheet sample (1) | 10 : 1 | Shore A 95 to 100 |
| Sheet sample (2) | 2 : 1 | Shore A 85 to 95 |
| Sheet sample (3) | 1 : 1 | Shore A 75 to 85 |
| Sheet sample (4) | 1 : 2 | Shore A 60 to 75 |
| Sheet sample (5) | 1 : 10 | Shore A 30 to 50 |
| Sheet sample (8) | Only thermoplastic | Shore A to 1: |
| | elastomer | Shore E to 5 |

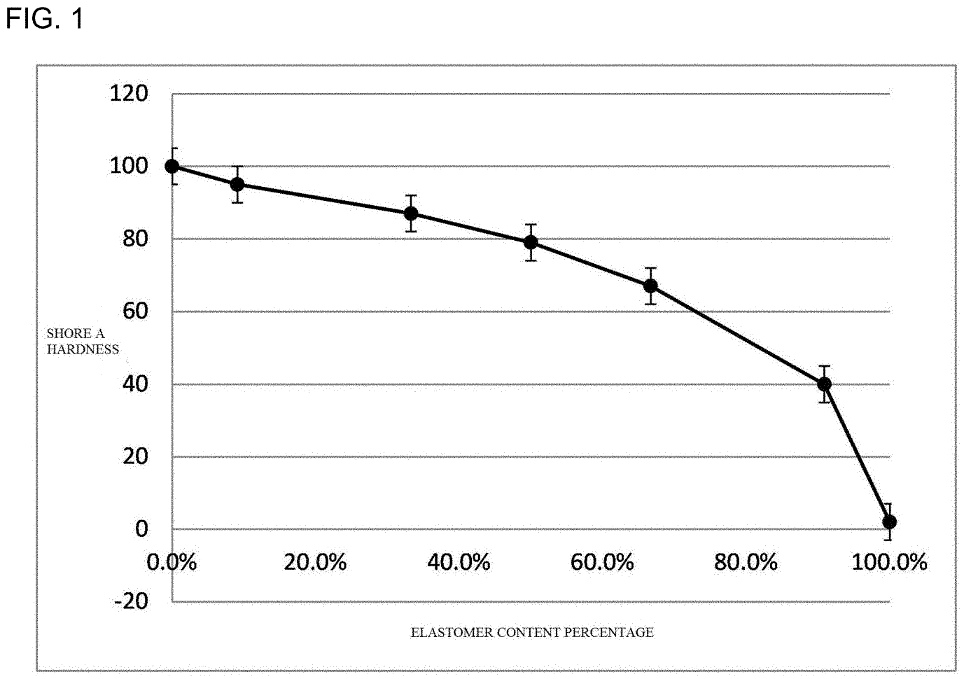

In addition, FIG. 1 is a graph showing a content percentage and a Shore A hardness of a thermoplastic elastomer when a total of 100% by weight of a polylactic acid resin and a thermoplastic elastomer are mixed with each other in the filaments according to the embodiment, and is obtained by plotting the data in Table 1 as measurement errors ±5.

As shown in Table 1 and FIG. 1, it is found that, when the content percentage of the thermoplastic elastomer is increased, the Shore A hardness decreases.

### B Tensile Strength and Elongation (Sheet Sample (5))

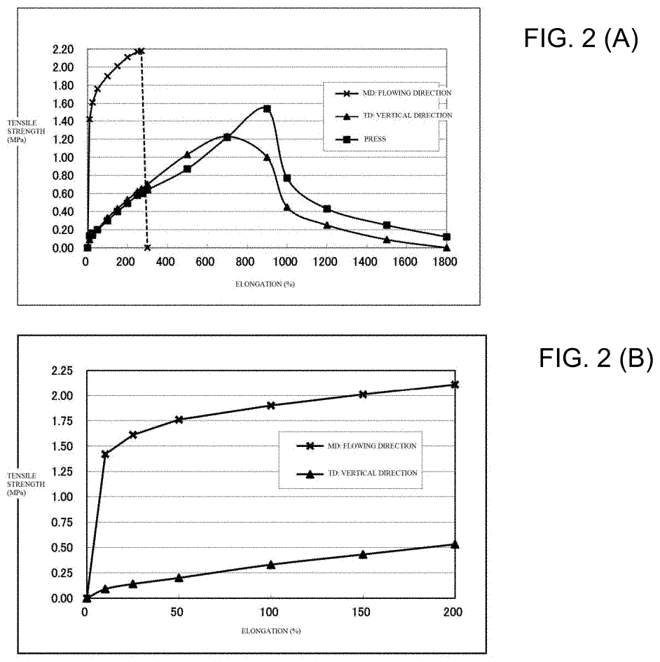

FIG. 2A is a graph showing a relationship between an elongation and a tensile strength in a sheet sample extruded on the same conditions as those of the filament according to the embodiment, and FIG. 2B is a graph in which an elongation range of 0% to 200% is extended.

FIG. 3 is a plan view of the sheet sample used in the measurements in FIGS. 2A and 2B. As shown in FIG. 3, a direction parallel to an extrusion direction is defined as a flowing direction (MD: Machine direction), and a direction vertical to the extrusion direction is defined as a transverse direction (TD: Transverse direction). In addition, the elongation and the tensile strength were measured as reference values with respect to a thickness direction of the sheet.

As shown in FIGS. 2A and 2B, the sheet sample according to the embodiment begun to elongate until 1.25 Mpa was applied in the flowing direction, and was broken when the force exceeded 2.22 MPa.

On the other hand, as shown in FIGS. 2A and 2B, the sheet sample according to the embodiment begun to elongate when 0.1 MPa was applied in the transverse direction and elongated to the end when the force exceeds 1 MPa.

As described above, it is found that the sheet sample according to the embodiment has such anisotropy that the sample sheet is not easily elongated (not easily deformed) in a direction parallel to the extrusion direction and is easily elongated (easily deformed) in a direction vertical to the extrusion direction.

As shown in FIG. 2A, since an elongation and a tensile strength equal to those in the transverse direction can be obtained in the thickness direction of the sheet, it can be said that the results of this experiment do not depend on the shape of the sample. In fact, a filament manufactured by the same extrusion has the same anisotropy.

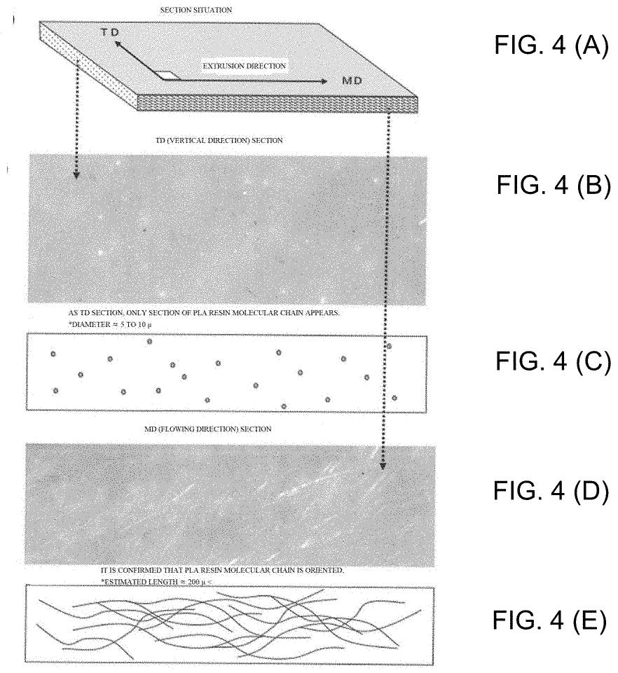

FIG. 4A is a perspective view of a sheet sample extruded on the same conditions as those of the filament according to the embodiment, FIG. 4B is a vertical sectional view (200 times) obtained by observing the sheet sample in FIG. 4A by a scanning electron microscope, FIG. 4C is a pattern diagram of FIG. 4B, FIG. 4D is a flowing-direction sectional view (200 times) obtained by observing the sheet sample in FIG. 4A by a scanning electron microscope (SEM), and FIG. 4E is a pattern diagram of FIG. 4D.

As shown in FIG. 4A, as in FIG. 3, a direction parallel to the extrusion direction is defined as a flowing direction (MD: Machine direction), and a direction vertical to the extrusion direction is defined as a transverse direction (TD: Transverse direction).

As shown in FIGS. 4B, 4C, 4D and 4E, in the sheet sample according to the embodiment, it is found that molecular chains of the polylactic acid (PLA) resin are oriented in parallel to the extrusion direction.

More specifically, according to the results shown in FIGS. 2A and 2B and the results shown in FIGS. 4B, 4C, 4D and 4E, it is found that the sample has such anisotropy that the sample is not easily elongated (deformed) in a direction parallel to the extrusion direction in which the molecular chains of the polylactic acid resin ware oriented, and the sample is easily elongated (deformed) in a direction vertical to the extrusion direction in which the molecular chains of the polylactic acid resin are not oriented.

Thus, the anisotropy to the deformation of the sheet sample according to the embodiment described above is determined to be caused by orienting the molecular chains of the polylactic acid resin by extrusion.

Since the anisotropy to the deformation of the sheet sample according to the embodiment is caused by the molecular chain orientation of the polylactic acid resin, it is inferred that, regardless of the types of thermoplastic elastomers, a filament or a sheet sample manufactured such that a polylactic acid resin and a thermoplastic elastomer are mixed with each other, heated, fused, and extruded elicits the same anisotropy.

### D Plasticizing Temperature (Filaments (1) to (7))

Table 2 shows results obtained by measuring plasticizing temperatures of the filaments (1) to (7) according to the embodiment.

TABLE 2

| | PLA · thermoplastic | Plasticizing |
|---|---|---|
| Sample | elastomer ratio | temperature |
| Filament (6) | Only PLA | 170° C. |
| Filament (1) | 10 : 1 | 100 to 170° C. |
| Filament (2) | 2 : 1 | 100 to 170° C. |
| Filament (3) | 1 : 1 | 100 to 170° C. |
| Filament (4) | 1 : 2 | 100 to 170° C. |
| Filament (5) | 1 : 10 | 100 to 170° C. |
| Filament (7) | Only thermoplastic | 100 to 170° C. |
| | elastomer | |

As shown in Table 2, except that the filament (6) made of only polylactic acid resin was 170° C., the filaments (1) to (5) and (7) begun to be softened at 100° C. and fused at 170° C.

In the filaments according to the embodiment, when the content percentages of thermoplastic elastomer increased, softening rates at 100° C. increased. However, a temperature at which the filaments are perfectly fused was 170° C.

As described above, since the plasticizing temperature of the polylactic acid resin is 170° C. and the plasticizing temperature of the thermoplastic elastomer is 100 to 170° C., in the filaments according to the embodiment, it is determined that the polylactic acid resin and the thermoplastic elastomer are sufficiently dispersed and present.

### E Three-Dimensional Printing Device (Filaments (1) to (3), (6))

In printing tests using the filaments (1) to (3) and (6) according to the embodiment, 100 or more three-dimensional printed matters each requiring about 30 min to 2 hours as duration are printed. However, even in any one of the filaments, a so-called jamming phenomenon in which a filament was bent and cannot be conveyed in a conveying process to the head or in the head did not occur, and defective supply or defective molding of the filaments caused by the jamming phenomenon were not observed.

The three-dimensional printing device according to the embodiment could be used without changing the setting of the heater part when the temperature of the heater part was set to 230 even though the filaments (1) to (3) and (6) having different content percentages of thermoplastic elastomer were used.

As shown in Table 1, the filaments (2) and (3) according to the embodiment are soft filaments in which Shore A hardnesses are 85 to 95 and 75 to 85. However, since printing could be performed by using the soft filaments, a molded object such as a part requiring flexibility could be manufactured.

In a three-dimensional printing device of a dual-head type which can simultaneously use materials of two types, when the filament according to the embodiment was used as a support material supporting a target object, it could be found that the filament had sufficient strength as a supporter and the support material could be easily peeled from the support material.

### [Operations•Advantages]

As described above, since the filament according to the embodiment contains polylactic acid having a high hardness and a thermoplastic elastomer having a low hardness, as shown in Table 1 and FIG. 1, a ratio of the polylactic acid and the thermoplastic elastomer can continuously change the hardness.

On the other hand, as shown in Table 2, in the filament according to the embodiment, since the plasticizing temperature of the polylactic acid and the plasticizing temperature of the thermoplastic elastomer are equal to each other, regardless of the ratio of the polylactic acid and the thermoplastic elastomer, an almost constant plasticizing temperature is exhibited.

Thus, a filament has an arbitrary hardness between the hardness of the polylactic acid and the hardness of the plasticizing elastomer even though a plasticizing temperature is almost constant can be provided.

As a result, of the filaments each containing polylactic acid and a thermoplastic elastomer, with respect to a filament containing a predetermined ratio or more of polylactic acid having a high hardness, as a raw filament for a three-dimensional printing device of an ordinary fused deposition modeling method (FDM), a filament which fulfills two conditions, i.e., a plasticizing temperature at which the filament can be fused by the heater and a predetermined hardness or more at which the filament is not bent during conveyance can be provided.

In addition, as shown in Table 1 and FIG. 1, in the method of manufacturing a filament according to the embodiment, since a filament in which a polylactic acid resin having a high hardness and a thermoplastic elastomer having a low hardness are mixed with each other at an arbitrary ratio is manufactured by extrusion, depending on the ratio of the polylactic acid and the thermoplastic elastomer, the filament having an arbitrary hardness between the hardness of the polylactic acid and the hardness of the thermoplastic elastomer can be molded.

On the other hand, as shown in Table 2, in the method of manufacturing a filament according to the embodiment, since the plasticizing temperature of the polylactic acid and the plasticizing temperature of the thermoplastic elastomer are equal to each other, regardless of the ratio of the polylactic acid and the thermoplastic elastomer, a filament exhibiting an almost constant plasticizing temperature can be molded.

As a result, a method of manufacturing a filament which can mold a filament having an arbitrary hardness between the hardness of the polylactic acid and the hardness of the thermoplastic elastomer although a plasticizing temperature is almost constant can be provided.

In the method of manufacturing a filament according to the embodiment, when a filament is manufactured by extrusion, as shown in FIGS. 2A and 2B, the molded filament has such anisotropy that the filament is not easily deformed in the extrusion direction and is easily deformed in a direction orthogonal to the extrusion direction.

Thus, when the filament molded by the method of manufacturing a filament according to the embodiment is used as a raw filament for a three-dimensional printing device of a fused deposition modeling method (FDM), since a conveying direction to the head is matched with the extrusion direction of the filament, the filament has rigidity with respect to the conveying direction to the head.

As a result, a so-called jamming phenomenon in which the filament is bent in a conveying process to the head or in the head and cannot be conveyed can be prevented from occurring.

In addition, when the filament is ordinarily conveyed in the three-dimensional printing device, the filament is drawn and conveyed while being nipped by a drive gear having grooves and a roller.

At this time, when the filament molded by the method of manufacturing a filament according to the embodiment is used as a raw filament for a three-dimensional printing device of a fused deposition modeling method (FDM), when the filament is nipped by the drive gear and the roller, the filament is strongly pressed against the grooves of the drive gear. However, since the pressing direction is a direction orthogonal to the extrusion direction of the filament, the filament is easily deformed as described above.

As a result, the filament is deformed in accordance with the grooves of the drive gear, and the filament is meshed with the grooves of the drive gear to make it possible to prevent the filament from slipping.

Thus, when the filament according to the embodiment is used in the three-dimensional printing device using the fused deposition modeling (FDM) method, a three-dimensional molded object can be stably printed over a long period of time.

As a result, by the filament according to the embodiment, a large three-dimensional molded object having flexibility or a three-dimensional molded object having high accuracy can be obtained.

### Second Embodiment

The filament and the method of manufacturing a filament according to the present invention will be described in detail on the basis of a second embodiment and examples.

A filament according to the embodiment is a filament used as a material of a printed matter printed by a three-dimensional printing device using a fused deposition modeling method (FDM) as a basic configuration, and is a filament containing a polylactic acid resin and a thermoplastic elastomer.

A method of manufacturing a filament according to the embodiment includes the mixing step of mixing a polylactic acid resin and a thermoplastic elastomer with each other to form a mixture and the molding step of molding the obtained mixture into a filament by extrusion, and includes the thermoplastic elastomer forming step of, before the mixing step, adjusting a weight mixing ratio of an olefinic resin and a mineral-oil-based plasticizer to a predetermined ratio to form a thermoplastic elastomer.

### [Steps in Manufacturing Filament]

A filament according to the embodiment is manufactured by using an ordinary extruder.

As the extruder, a 65ϕ extruder is used. As cylinder temperatures of the extruder, 150 to 180° C. at a dice, 160 to 200° C. at a measuring part, 160 to 200° C. at a compressing part, and 150 to 180° C. at a supply part.

A limit temperature is 240° C., a temperature of cooling water in a cooling tank ranges from 8 to 15° C., a die-sizer distance ranges from 2 to 5 cm, a draw down ratio ranges from 0.87 to 0.92, and a dry vacuum scheme is used as a die-sizing scheme.

In the filament according to the embodiment, after a total of 100% by weight of a pellet of a polylactic acid resin (A) and a pellet of a thermoplastic elastomer (B) are mixed with each other, the mixed pellet is put in an inlet of an extrusion machine, and a screw is rotated while being heated to fuse and feed the resin. The resin is extruded from a mold at the distal end and cooled and solidified in the cooling tank to manufacture a filament having a diameter of 1.75 mm.

### [Three-Dimensional Print Device]

A three-dimensional printing device to which the filament according to the embodiment is applied is a device using a fused deposition modeling method (FDM) and is a device including a data processing unit and a printing unit performing three-dimensional printing on the basis of a control signal supplied from the data processing unit.

The printing unit has a head part including a heater part and a nozzle part, and the head part has a drive gear supplying a raw filament to the nozzle part and a roller. Grooves are formed in the drive gear.

In the three-dimensional printing device, the raw filament is drawn while being nipped by the drive gear and the roller and conveyed to the head part and fused by the heater part. The fused filament is discharged from the nozzle part and three-dimensionally laminated as a printed matter.

### <Raw Materials>

### [Polylactic Acid Resin]

A polylactic acid resin according to the embodiment has a purity of 70% or more (containing additives of 30% or less) by weight and a plasticizing temperature of 170° C. In the polylactic acid resin according to the present invention, a D-form content is preferably 1.0 mol % or less, or the D-form content is preferably 99.0 mol % or more. In particular, the content is preferably 0.1 to 0.6 mol % or 99.4 to 99.9 mol %.

When the D-form content falls within the range, since crystalline property is good, moldability is good (short molding cycle), and the heat resistance of the obtained molded object is improved.

### [Thermoplastic Elastomer]

A thermoplastic elastomer according to the embodiment contains an olefinic resin and a mineral-oil-based plasticizer. More specifically, a weight mixing ratio of a (C) i.e. olefinic resin component and a (D) i.e. mineral-oil-based plasticizer component is given by (C) component/(D) component=20:80 to 60:40, and plasticizing temperature ranges 100 to 170° C.

### [Olefinic Resin]

The olefinic resin is a chain carbon hydride and has physicality changing depending on a degree of crystallinity. As the olefinic resin, polyethylene (PE) or polypropylene (PP) are given. The olefinic resin ordinarily has a small relative gravity, high resistance to chemicals, and good fluidity. An olefinic elastomer generally contains polypropylene as a hard segment and ethylene propylene rubber as a soft segment.

### [Mineral-Oil-Based Plasticizer]

In the embodiment, as a plasticizer in the thermoplastic elastomer, a mineral-oil-based plasticizer is used. In the embodiment, mineral oil such as known paraffinic oil or naphthenic oil can be used. Of these oils, a mineral oil which is refined petroleum paraffin hydrocarbon containing paraffin having preferable compatibility as a main component is preferably used.

A filament and a method of manufacturing a filament will be described below.

### Example 1

A filament according to Example 1 is a filament obtained such that a thermoplastic elastomer is formed to contain an olefinic resin and a mineral-oil-based plasticizer at a weight mixing ratio of 20:80 in the thermoplastic elastomer forming step and a polylactic acid resin and the thermoplastic elastomer are mixed with each other at a ratio of 10 parts by weight:1 part by weight.

### Example 2

A filament according to Example 2 is a filament obtained such that a thermoplastic elastomer is formed to contain an olefinic resin and a mineral-oil-based plasticizer at a weight mixing ratio of 20:80 in the thermoplastic elastomer forming step and a polylactic acid resin and the thermoplastic elastomer are mixed with each other at a ratio of 2 parts by weight:1 part by weight.

### Example 3

A filament according to Example 3 is a filament obtained such that a thermoplastic elastomer is formed to contain an olefinic resin and a mineral-oil-based plasticizer at a weight mixing ratio of 20:80 in the thermoplastic elastomer forming step and a polylactic acid resin and the thermoplastic elastomer are mixed with each other at a ratio of 1 part by weight:1 part by weight.

### Example 4

A filament according to Example 4 is a filament obtained such that a thermoplastic elastomer is formed to contain an olefinic resin and a mineral-oil-based plasticizer at a weight mixing ratio of 20:80 in the thermoplastic elastomer forming step and a polylactic acid resin and the thermoplastic elastomer are mixed with each other at a ratio of 1 part by weight:2 part by weight.

### Example 5

A filament according to Example 5 is a filament obtained such that a thermoplastic elastomer is formed to contain an olefinic resin and a mineral-oil-based plasticizer at a weight mixing ratio of 20:80 in the thermoplastic elastomer forming step and a polylactic acid resin and the thermoplastic elastomer are mixed with each other at a ratio of 1 part by weight:10 parts by weight.

### Comparative Example 1

A filament according to Comparative Example 1 is a filament obtained such that a thermoplastic elastomer is formed to contain an olefinic resin and a mineral-oil-based plasticizer at a weight mixing ratio of 20:80 in the thermoplastic elastomer forming step and the filament is configured by only the thermoplastic elastomer without the mixing step.

### Example 6

A filament according to Example 6 is a filament obtained such that a thermoplastic elastomer is formed to contain an olefinic resin and a mineral-oil-based plasticizer at a weight mixing ratio of 30:70 in the thermoplastic elastomer forming step and a polylactic acid resin and the thermoplastic elastomer are mixed with each other at a ratio of 10 parts by weight:1 part by weight.

### Example 7

A filament according to Example 7 is a filament obtained such that a thermoplastic elastomer is formed to contain an olefinic resin and a mineral-oil-based plasticizer at a weight mixing ratio of 30:70 in the thermoplastic elastomer forming step and a polylactic acid resin and the thermoplastic elastomer are mixed with each other at a ratio of 2 parts by weight:1 part by weight.

### Example 8

A filament according to Example 8 is a filament obtained such that a thermoplastic elastomer is formed to contain an olefinic resin and a mineral-oil-based plasticizer at a weight mixing ratio of 30:70 in the thermoplastic elastomer forming step and a polylactic acid resin and the thermoplastic elastomer are mixed with each other at a ratio of 1 part by weight:1 part by weight.

### Example 9

A filament according to Example 9 is a filament obtained such that a thermoplastic elastomer is formed to contain an olefinic resin and a mineral-oil-based plasticizer at a weight mixing ratio of 30:70 in the thermoplastic elastomer forming step and a polylactic acid resin and the thermoplastic elastomer are mixed with each other at a ratio of 1 part by weight:2 parts by weight.

### Example 10

A filament according to Example 5 is a filament obtained such that a thermoplastic elastomer is formed to contain an olefinic resin and a mineral-oil-based plasticizer at a weight mixing ratio of 30:70 in the thermoplastic elastomer forming step and a polylactic acid resin and the thermoplastic elastomer are mixed with each other at a ratio of 1 part by weight:10 parts by weight.

### Comparative Example 2

A filament according to Comparative Example 2 is a filament obtained such that a thermoplastic elastomer is formed to contain an olefinic resin and a mineral-oil-based plasticizer at a weight mixing ratio of 30:70 in the thermoplastic elastomer forming step and the filament is configured by only the thermoplastic elastomer without the mixing step.

### Example 11

A filament according to Example 11 is a filament obtained such that a thermoplastic elastomer is formed to contain an olefinic resin and a mineral-oil-based plasticizer at a weight mixing ratio of 40:60 in the thermoplastic elastomer forming step and a polylactic acid resin and the thermoplastic elastomer are mixed with each other at a ratio of 10 parts by weight:1 part by weight.

### Example 12

A filament according to Example 12 is a filament obtained such that a thermoplastic elastomer is formed to contain an olefinic resin and a mineral-oil-based plasticizer at a weight mixing ratio of 40:60 in the thermoplastic elastomer forming step and a polylactic acid resin and the thermoplastic elastomer are mixed with each other at a ratio of 2 parts by weight:1 part by weight.

### Example 13

A filament according to Example 13 is a filament obtained such that a thermoplastic elastomer is formed to contain an olefinic resin and a mineral-oil-based plasticizer at a weight mixing ratio of 40:60 in the thermoplastic elastomer forming step and a polylactic acid resin and the thermoplastic elastomer are mixed with each other at a ratio of 1 part by weight:1 part by weight.

### Example 14

A filament according to Example 14 is a filament obtained such that a thermoplastic elastomer is formed to contain an olefinic resin and a mineral-oil-based plasticizer at a weight mixing ratio of 40:60 in the thermoplastic elastomer forming step and a polylactic acid resin and the thermoplastic elastomer are mixed with each other at a ratio of 1 part by weight:2 parts by weight.

### Example 15

A filament according to Example 15 is a filament obtained such that a thermoplastic elastomer is formed to contain an olefinic resin and a mineral-oil-based plasticizer at a weight mixing ratio of 40:60 in the thermoplastic elastomer forming step and a polylactic acid resin and the thermoplastic elastomer are mixed with each other at a ratio of 1 part by weight:10 parts by weight.

### Comparative Example 3

A filament according to Comparative Example 3 is a filament obtained such that a thermoplastic elastomer is formed to contain an olefinic resin and a mineral-oil-based plasticizer at a weight mixing ratio of 40:60 in the thermoplastic elastomer forming step and the filament is configured by only the thermoplastic elastomer without the mixing step.

### Example 16

A filament according to Example 16 is a filament obtained such that a thermoplastic elastomer is formed to contain an olefinic resin and a mineral-oil-based plasticizer at a weight mixing ratio of 50:50 in the thermoplastic elastomer forming step and a polylactic acid resin and the thermoplastic elastomer are mixed with each other at a ratio of 10 parts by weight:1 part by weight.

### Example 17

A filament according to Example 17 is a filament obtained such that a thermoplastic elastomer is formed to contain an olefinic resin and a mineral-oil-based plasticizer at a weight mixing ratio of 50:50 in the thermoplastic elastomer forming step and a polylactic acid resin and the thermoplastic elastomer are mixed with each other at a ratio of 2 parts by weight:1 part by weight.

### Example 18

A filament according to Example 18 is a filament obtained such that a thermoplastic elastomer is formed to contain an olefinic resin and a mineral-oil-based plasticizer at a weight mixing ratio of 50:50 in the thermoplastic elastomer forming step and a polylactic acid resin and the thermoplastic elastomer are mixed with each other at a ratio of 1 part by weight:1 part by weight.

### Example 19

A filament according to Example 19 is a filament obtained such that a thermoplastic elastomer is formed to contain an olefinic resin and a mineral-oil-based plasticizer at a weight mixing ratio of 50:50 in the thermoplastic elastomer forming step and a polylactic acid resin and the thermoplastic elastomer are mixed with each other at a ratio of 1 part by weight:2 parts by weight.

### Example 20

A filament according to Example 20 is a filament obtained such that a thermoplastic elastomer is formed to contain an olefinic resin and a mineral-oil-based plasticizer at a weight mixing ratio of 50:50 in the thermoplastic elastomer forming step and a polylactic acid resin and the thermoplastic elastomer are mixed with each other at a ratio of 1 part by weight:10 parts by weight.

### Comparative Example 4

A filament according to Comparative Example 4 is a filament obtained such that a thermoplastic elastomer is formed to contain an olefinic resin and a mineral-oil-based plasticizer at a weight mixing ratio of 50:50 in the thermoplastic elastomer forming step and the filament is configured by only the thermoplastic elastomer without the mixing step.

### Example 21

A filament according to Example 21 is a filament obtained such that a thermoplastic elastomer is formed to contain an olefinic resin and a mineral-oil-based plasticizer at a weight mixing ratio of 60:40 in the thermoplastic elastomer forming step and a polylactic acid resin and the thermoplastic elastomer are mixed with each other at a ratio of 10 parts by weight:1 part by weight.

### Example 22

A filament according to Example 22 is a filament obtained such that a thermoplastic elastomer is formed to contain an olefinic resin and a mineral-oil-based plasticizer at a weight mixing ratio of 60:40 in the thermoplastic elastomer forming step and a polylactic acid resin and the thermoplastic elastomer are mixed with each other at a ratio of 2 parts by weight:1 part by weight.

### Example 23

A filament according to Example 23 is a filament obtained such that a thermoplastic elastomer is formed to contain an olefinic resin and a mineral-oil-based plasticizer at a weight mixing ratio of 60:40 in the thermoplastic elastomer forming step and a polylactic acid resin and the thermoplastic elastomer are mixed with each other at a ratio of 1 part by weight:1 part by weight.

### Example 24

A filament according to Example 24 is a filament obtained such that a thermoplastic elastomer is formed to contain an olefinic resin and a mineral-oil-based plasticizer at a weight mixing ratio of 60:40 in the thermoplastic elastomer forming step and a polylactic acid resin and the thermoplastic elastomer are mixed with each other at a ratio of 1 part by weight:2 parts by weight.

### Example 25

A filament according to Example 25 is a filament obtained such that a thermoplastic elastomer is formed to contain an olefinic resin and a mineral-oil-based plasticizer at a weight mixing ratio of 60:40 in the thermoplastic elastomer forming step and a polylactic acid resin and the thermoplastic elastomer are mixed with each other at a ratio of 1 part by weight:10 parts by weight.

### Comparative Example 5

A filament according to Comparative Example 5 is a filament obtained such that a thermoplastic elastomer is formed to contain an olefinic resin and a mineral-oil-based plasticizer at a weight mixing ratio of 60:40 in the thermoplastic elastomer forming step and the filament is configured by only the thermoplastic elastomer without the mixing step.

Table 3 shows experiment results of Shore A hardnesses, measured values of plasticizing temperatures (° C.), extruding possibilities, and molding possibilities of the filaments in Example 1 to Example 25, Comparative Example 1 to Comparative Example 5, and Reverence Example 1.

TABLE 3

| | Thermoplastic | | | | | |
|---|---|---|---|---|---|---|
| | elastomer | | | | | |
| | [olefinic resin: | Filament | | | | |
| | mineral-oil-based | “polylactic | Shore A | | | |
| | plasticizer] | acid resin: | hardness | Plasticizing | | |
| | (Shore A | thermoplastic | (sheet | temperature | Possibility | Possibility |
| | hardness 0) | elastomer” | sample) | (° C.) | of extrusion | of molding |
| Example 1 | 20:80 | 10:1 | 95 to 100 | 100 to 170 | ◯ | ◯ |
| Example 2 | | 2:1 | 85 to 95 | 100 to 170 | ◯ | ◯ |
| Example 3 | | 1:1 | 75 to 85 | 100 to 170 | ◯ | ◯ |
| Example 4 | | 1:2 | 55 to 75 | 100 to 170 | ◯ | Δ |
| Example 5 | | 1:10 | 30 to 55 | 100 to 170 | ◯ | Δ |
| Comparative | | Only | 1 or more | 100 to 170 | ◯ | X |
| Example 1 | | elastomer | (Shore E: | | | |
| | | | 5 or less) | | | |
| | Thermoplastic | | | | | |
| | elastomer | | | | | |
| | [olefinic resin: | Filament | | | | |
| | mineral-oil-based | “polylactic | Shore A | | | |
| | plasticizer] | acid resin: | hardness | Plasticizing | | |
| | (Shore A | thermoplastic | (sheet | temperature | Possibility | Possibility |
| | hardness 5) | elastomer” | sample) | (° C.) | of extrusion | of molding |
| Example 6 | 30:70 | 10:1 | 95 to 100 | 100 to 170 | ◯ | ◯ |
| Example 7 | | 2:1 | 85 to 95 | 100 to 170 | ◯ | ◯ |
| Example 8 | | 1:1 | 75 to 85 | 100 to 170 | ◯ | ◯ |
| Example 9 | | 1:2 | 60 to 75 | 100 to 170 | ◯ | Δ |
| Example 10 | | 1:10 | 30 to 60 | 100 to 170 | ◯ | Δ |
| Comparative | | Only | 5 | 100 to 170 | ◯ | X |
| Example 2 | | elastomer | | | | |
| | Thermoplastic | | | | | |
| | elastomer | | | | | |
| | [olefinic resin: | Filament | | | | |
| | mineral-oil-based | “polylactic | Shore A | | | |
| | plasticizer] | acid resin: | hardness | Plasticizing | | |
| | (Shore A | thermoplastic | (sheet | temperature | Possibility | Possibility |
| | hardness 20) | elastomer” | sample) | (° C.) | of extrusion | of molding |
| Example 11 | 40:60 | 10:1 | 95 to 100 | 100 to 170 | ◯ | ◯ |
| Example 12 | | 2:1 | 95 to 98 | 100 to 170 | ◯ | ◯ |
| Example 13 | | 1:1 | 80 to 95 | 100 to 170 | ◯ | ◯ |
| Example 14 | | 1:2 | 70 to 80 | 100 to 170 | ◯ | ◯ |
| Example 15 | | 1:10 | 40 to 70 | 100 to 170 | ◯ | Δ |
| Comparative | | Only | 20 | 100 to 170 | ◯ | X |
| Example 3 | | elastomer | | | | |
| | Thermoplastic | | | | | |
| | elastomer | | | | | |
| | [olefinic resin: | Filament | | | | |
| | mineral-oil-based | “polylactic | Shore A | | | |
| | plasticizer] | acid resin: | hardness | Plasticizing | | |
| | (Shore A | thermoplastic | (sheet | temperature | Possibility | Possibility |
| | hardness 50) | elastomer” | sample) | (° C.) | of extrusion | of molding |
| Example 16 | 50:50 | 10:1 | 98 to 100 | 100 to 170 | ◯ | ◯ |
| Example 17 | | 2:1 | 95 to 98 | 100 to 170 | ◯ | ◯ |
| Example 18 | | 1:1 | 85 to 95 | 100 to 170 | ◯ | ◯ |
| Example 19 | | 1:2 | 75 to 85 | 100 to 170 | ◯ | ◯ |
| Example 20 | | 1:10 | 60 to 75 | 100 to 170 | ◯ | ◯ |
| Comparative | | Only | 50 | 100 to 170 | ◯ | Δ |
| Example 4 | | elastomer | | | | |
| | Thermoplastic | | | | | |
| | elastomer | | | | | |
| | [olefinic resin: | Filament | | | | |
| | mineral-oil-based | “polylactic | Shore A | | | |
| | plasticizer] | acid resin: | hardness | Plasticizing | | |
| | (Shore A | thermoplastic | (sheet | temperature | Possibility | Possibility |
| | hardness 70) | elastomer” | sample) | (° C.) | of extrusion | of molding |
| Example 21 | 60:40 | 10:1 | 98 to 100 | 100 to 170 | ◯ | ◯ |
| Example 22 | | 2:1 | 95 to 98 | 100 to 170 | ◯ | ◯ |
| Example 23 | | 1:1 | 85 to 95 | 100 to 170 | ◯ | ◯ |
| Example 24 | | 1:2 | 75 to 85 | 100 to 170 | ◯ | Δ |
| Example 25 | | 1:10 | 70 to 75 | 100 to 170 | ◯ | Δ |
| Comparative | | Only | 70 | 100 to 170 | ◯ | X |
| Example 5 | | elastomer | | | | |
| Reference | — | Only PLA | 100 or more | 170 | ◯ | ◯ |
| Example | | | | | | |

The “Shore A hardness” in Table 3 was measured based on JIS K 7215 (plastic). More specifically, a test piece has a thickness of 5 mm, and a sheet sample containing the same components as those of the filaments in Examples 1 to 25 obtained by extrusion was manufactured by performing punching process. A test temperature is 23° C., and a test device is Shimazu durometer A available from SHIMAZU CORPORATION.

The Shore E hardness in Table 3 was measured by using Shimazu durometer E available from SHIMAZU CORPORATION on the basis of JIS K 6253 (vulcanized rubber and thermoplastic rubber). The other conditions are the same as those in the measurement for the Shore A hardness.

The plasticizing temperature in Table 3 is a temperature at which the material does not return to the original shape, and is a temperature at which a filament serving as a material for molding is fused by heat.

As shown in Table 3, the plasticizing temperature of the filament made of only a polylactic acid resin shown as Reference example is 170° C. Each of the filaments in Examples 1 to 25 and

### Comparative Examples 1 to 5 Begun to be Softened at 100° C. and was Fused (Plasticized) at 170° C.

In the filament of each example and each comparative example, as the thermoplastic elastomer content increased, the rate of softening at 100° C. increased, but the filament completely fused at 170° C.

The plasticizing temperature of the polylactic acid resin is 170° C., and the plasticizing temperature of the thermoplastic elastomer ranges of 100 to 170° C. Thus, the polylactic acid resin and the thermoplastic elastomer contained in the filament of each of the Examples are sufficiently dispersed at 170° C. or a temperature close thereto in terms of usefulness, and the hardness of the filament is uniformed.

The “possibilities of extrusion” in Table 3 are obtained by determining whether filaments which can be extruded from the extruder, can be kept in a linear filament shape, and can be winded can be manufactured.

The determination “◯” represents that a molded object can be manufactured by applying a generally distributed three-dimensional printing device.

The determination “Δ” represents that a molded object can be manufactured by adding a configuration specified to the filament of each of the examples to the three-dimensional printing device.

The determination “?” represents that a filament cannot be manufactured at the present technical level related to an extrusion device.

The “possibilities of molding” in Table 3 are obtained by determining whether filaments preferably projected from a head part of a three-dimensional printing device and molded object can be manufactured.

The determination “◯” represents that a molded object can be manufactured by applying a generally distributed three-dimensional printing device.

The determination “Δ” represents that a molded object can be manufactured by adding a configuration specified to the filament of each of the examples to the three-dimensional printing device.

The determination “?” represents that a filament cannot be manufactured at the present technical level related to a three-dimensional printing device.

The “possibilities of molding” in Table 3 will be described below.

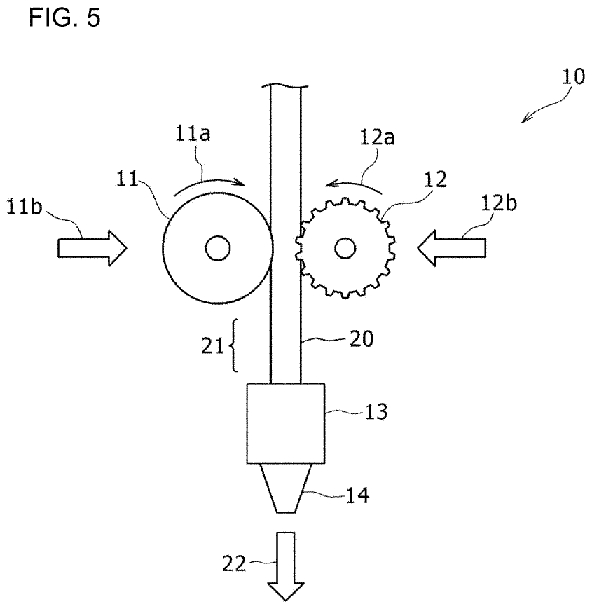

FIG. 5 is a diagram showing a filament conveying mechanism in a head part of a three-dimensional printing device. At a head part 10 of the three dimensional printing device, a filament 20 is nipped by a roller 11 and a drive gear 12.

When the roller 11 and the drive gear 12 rotate, the filament 20 is guided to a heater part 13, heated and fused, conveyed toward a nozzle 14, and projected from an opening (not shown) of the nozzle 14. Reference 22 denotes a projection direction of the filament 20 after the filament 20 is fused.

Reference numeral 11a denotes a rotating direction of the roller 11, and reference numeral 12a denotes a rotating direction of the drive gear 12. Reference numeral 11b denotes regulating force acting on the roller 12 and force pressing the roller 11 against the drive gear 12. Reference numeral 12b denotes regulating force acting on the drive gear 12 and force pressing the drive gear 12 against the roller 11. The filament 20 is reliably nipped by the regulating force 11b and the regulating force 12a such that the roller 11 and the drive gear 12 contact with each other.

Although the filament 20 is reliably nipped by the roller 11 and the drive gear 12, on the other hand, when the Shore A hardness of the filament 20 decreases, the degrees of deformation and collapse in a direction orthogonal to an axial direction (direction of projection direction 22) increase by nipping by the roller 11 and the drive gear 12. In this manner, the filament 20 is bent or broken in an important region 21 of the filament 20 and cannot be conveyed to the nozzle 14. As a result, a molded object cannot be manufactured. The “possibility of molding”=“?” denotes a filament from which a molded object cannot be manufactured for the above reasons.

### [Conditions of Experiment]

Temperature of heater part 13: 230° C.
Processing speed (head speed): 20 to 40 mm/s
Lamination height (printing pitch=thickness per layer): 0.1 mm
Contents of molding (lamination printing): molding requiring about 30 min to 2 hours was performed two or more times.

The Shore A hardnesses, possibilities of extrusion, and possibilities of molding of the filaments in Examples 1 to 25 and Comparative Examples 1 to 5 obtained on the basis of the conditions of the experiment are shown in Table 3.

### (Effects)

On the basis of the experiment results shown in Table 3, effects of the filaments in the examples will be described below.

The filaments in Examples 1 to 25 are filaments used as materials of a printed matter printed by a three-dimensional printing device using a fused deposition modeling method (FDM) and contains a polylactic acid resin and a thermoplastic elastomer.

Since the filament in each of the examples contains the polylactic acid resin having a high hardness and the thermoplastic elastomer having a low hardness, the hardness of the filament can be continuously changed depending on the rate of the polylactic acid resin and the thermoplastic elastomer.

As shown in Table 3, the plasticizing temperature of the polylactic acid resin in Reference Example is 170° C., and plasticizing temperatures of the filaments in the examples are 170° C. (start of plasticizing at 100° C. to completion of plasticizing at 170° C.). The plasticizing temperatures of the filaments in the examples are almost constant regardless of the ratio of the polylactic acid resin and the thermoplastic elastomer.

More specifically, the filament in each of the examples has an arbitrary hardness between the hardness of the polylactic acid resin and the hardness of the thermoplastic elastomer, and the polylactic acid resin and the thermoplastic elastomer can be simultaneously uniformly plasticized (thermally fused).

Thus, according to the filament in each of the examples, a filament which can give an arbitrary hardness to a three-dimensional molded object and has a hardness at which the filament is not bent in a conveying process can be provided.

In particular, in the filaments in Examples 1 to 25 containing a polylactic acid resin and a thermoplastic elastomer at ratios ranging from 10 parts by weight:1 part by weight to 1 part by weight:10 parts by weight, the thermoplastic elastomer containing an olefinic resin and a mineral-oil-based plasticizer at weight mixing ratios ranging from 20:80 to 60:40, the “possibilities of molding”=“◯” or “Δ”. A generally distributed three-dimensional printing device is applied or a configuration specified to a filament is added to make it possible to manufacture a molded object.

Furthermore, in the filaments in Examples 1 to 3, 6 to 8, 11 to 14, 16 to 18, and 21 to 23 containing a polylactic acid resin and a thermoplastic elastomer at ratios ranging from 10 parts by weight:1 part by weight to 1 part by weight:1 part by weight, the thermoplastic elastomer containing an olefinic resin and a mineral-oil-based plasticizer at weight mixing ratios ranging from 20:80 to 60:40, the “possibilities of molding”=“◯”. A generally distributed three-dimensional printing device is applied to make it possible to manufacture a molded object.

Furthermore, in the filaments in Examples 16 to 25 containing a polylactic acid resin and a thermoplastic elastomer at ratios ranging from 10 parts by weight:1 part by weight to 1 part by weight:10 parts by weight, the thermoplastic elastomer containing an olefinic resin and a mineral-oil-based plasticizer at weight mixing ratios ranging from 50:50 to 60:40, the “possibilities of molding”=“◯”. A generally distributed three-dimensional printing device is applied to make it possible to manufacture a molded object.

In a filament containing at least a polylactic acid resin and a thermoplastic elastomer at a ratio ranging from 10 parts by weight:1 part by weight to 1 part by weight:10 parts by weight, the thermoplastic elastomer containing an olefinic resin and a mineral-oil-based plasticizer at a component ratio (for example, the weight mixing ratio of 99:1) which falls outside the ranges in the experiment results in Table 3 and lower than the the weight mixing ratio of 60:40 with respect to the mineral-oil-based plasticizer, the “possibilities of molding”=“◯”. A generally distributed three-dimensional printing device is applied to make it possible to manufacture a molded object.

In consideration of an influence such as a measurement error, even though the component ratio falls outside the ranges of the experiment results in Table 3, it is conceivable that there is a target filament. For example, when a filament contains a polylactic acid resin and a thermoplastic elastomer at an arbitrary ratio ranging from 10 parts by weight:1 part by weight to 1 part by weight:10 parts by weight, the thermoplastic elastomer containing an olefinic resin and a mineral-oil-based plasticizer at weight mixing ratios ranging from 10:90 to 70:30, the “possibilities of molding”=“◯” or “Δ”. It is conceivable that a configuration specified to at least a filament is added to make it possible to manufacture a molded object. As shown by the experiment results in Table 3, all the possibilities of extrusion” in Examples 1 to 25 were “◯”.

The experiment results in Table 3 are of the filaments containing polylactic acid resin of a degree of purity of 90% or more as a weight ratio. However, it was confirmed that determinations for “possibilities of extrusion” and “possibilities of molding” in Table 1 rarely change when the purity of the polylactic acid resin was 70% or more as a weight ratio. Thus, the polylactic acid resin of a purity of 70% or more as a weight ratio is preferably used. In particular, when the purity of the polylactic acid resin is 90% or more as a weight ratio, the experiment results in Table 3 can be preferably reproduced.

The filaments in the examples are manufactured by a method of manufacturing a filament including the mixing step of mixing a polylactic acid resin and a thermoplastic elastomer with each other to form a mixture and the molding step of molding the obtained mixture into a filament by extrusion, and including the thermoplastic elastomer forming step of, before the mixing step, adjusting a weight mixing ratio of an olefinic resin and a mineral-oil-based plasticizer to a predetermined ratio to form a thermoplastic elastomer.

Since the filaments in the examples are manufactured by using extrusion, the manufactured filaments have such anisotropy that the filaments are not easily deformed in an extrusion direction or a conveying direction and are easily deformed in a direction orthogonal to the conveying direction.

Since the filaments in the examples are not easily deformed in the conveying direction, a jamming phenomenon in which the filament is bent and cannot be conveyed can be prevented.

As shown in FIG. 5, since the filament (filament 20) in each of the embodiments is deformed easier in the direction orthogonal to the conveying direction than in the conveying direction, the filament is deformed in accordance with the grooves of the drive gear 12, preferably meshed with the grooves of the drive gear 12, and reliably conveyed.

### Third Embodiment

A filament according to the present invention will be described in detail with reference to a third embodiment and examples.

### [Steps in Manufacturing Filament]

A filament according to the embodiment is manufactured by using an ordinary extruder (not shown).

For example, a 65ϕ extruder is used. As cylinder temperatures, 150 to 180° C. at a dice, 160 to 200° C. at a measuring part, 160 to 200° C. at a compressing part, and 150 to 180° C. at a supply part.

A limit temperature is 240° C., a temperature of cooling water in a cooling tank ranges from 8 to 15° C., a die-sizer distance ranges from 2 to 5 cm, a draw down ratio ranges from 0.87 to 0.92, and a dry vacuum scheme is used as a die-sizing scheme.

In the filament according to the embodiment, after a total of 100% by weight of a pellet of a polylactic acid resin and a pellet of a thermoplastic elastomer are mixed with each other, the mixed pellet is put in an inlet of an extrusion machine, and a screw is rotated while being heated to fuse and feed the resin. The resin is extruded from a mold at the distal end and cooled and solidified in the cooling tank to manufacture a filament having a diameter of 1.75 mm.

### [Three-Dimensional Print Device]

A three-dimensional printing device (not shown) to which the filament according to the embodiment is applied is a device uses a fused deposition modeling method (FDM) and is configured to have a data processing unit and a printing unit performing three-dimensional printing on the basis of a control signal supplied from the data processing unit.

The printing unit has a head part including a heater part and a nozzle part, and the head part has a drive gear supplying a raw filament to the nozzle part and a roller. Grooves are formed in the drive gear.

The three-dimensional printing device according to the embodiment is configured such that the raw filament is drawn while being nipped by the drive gear and the roller and conveyed to the head part and fused by the heater part and the fused filament is discharged from the nozzle part to form a printed matter.

### [Raw Materials]

### A: Polylactic Acid Resin

A polylactic acid resin according to the present invention has a purity of 70% or more (containing additives of 30% or less) by weight and a plasticizing temperature of 170° C. In particular, when the purity of the polylactic acid resin is 95% or more (containing additives of 5% or less) by weight, the reproducibilities of the characteristics and effects of the filament (will be described later) become preferable.

In the polylactic acid resin according to the present invention, a D-form content is preferably 1.0 mol % or less, or the D-form content is preferably 99.0 mol % or more. In particular, the content is preferably 0.1 to 0.6 mol % or 99.4 to 99.9 mol %.

When the D-form content falls within the range, since crystalline property is good, moldability is good (short molding cycle), and the heat resistance of the obtained molded object is improved.

### <Thermoplastic Elastomer>

A thermoplastic elastomer according to the present invention contains an olefinic resin or a styrene resin and a mineral-oil-based plasticizer. More specifically, a weight mixing ratio of the olefinic resin or the styrene resin and the mineral-oil-based plasticizer (olefinic resin (or styrene resin):mineral-oil-based plasticizer) is, for example, 25% by weight:75% by weight to 60% by weight:40% by weight, and a plasticizing point (plasticizing temperature) ranges from 100 to 170° C.

### <Styrene Resin>

The styrene resin according to the present invention has a polystyrene block serving as a hard segment and conjugated diene polymer block serving as a soft segment, exhibits a vulcanized rubber-like physical property at a low temperature, and is heated and fused in a heating state to exhibit fluidity.

As the styrene elastomer, styrene-butadiene-styrene block copolymer (SBS), styrene-isoprene-styrene block copolymer (SIS), styrene-ethylene/butylene-styrene block copolymer (SEBS), styrene-ethylene/propylene-styrene block copolymer (SEPS), partially hydrogenated styrene-ethylene/butylene-styrene block copolymer (partially hydrogenated SEBS), styrene.(ethylene-ethylene/propylene)-styrene block copolymer (SEEPS), or the like are exemplified. When the SEBS or the SEEPS is used, transparency is improved, and a good anti-slip property is obtained.

### <Mineral-Oil-Based Plasticizer>

In the present invention, as a plasticizer in a thermoplastic elastomer, a mineral-oil-based plasticizer is used. In the present invention, a mineral oil such as known paraffinic oil or naphthenic oil can be used. Of the mineral oils, a mineral oil which is refined petroleum paraffin hydrocarbon oil containing paraffin preferably compatible with styrene elastomer as a main component is preferably used.

### <SROPE (Registered Trade Mark)>

As SROPE (Registered Trade Mark) serving as a functional agent, two types of SROPE, i.e., PE (polyethylene)-based PE-SROPE (Registered Trade Mark) and PP (polypropylene)-based PP-SROPE (Registered Trade Mark) are prepared.

The following Comparative Examples 1 to 3 and Examples 1 to 10 were prepared as filaments, and roundnesses of sectional shapes of the filaments were measured.

### Comparative Example 1

A filament in Comparative Example 1 is a filament manufactured by extruding a raw pellet of a polylactic acid resin of 100% by weight.

### Comparative Example 2

A filament in Comparative Example 2 is a filament manufactured by extruding a functional raw pellet obtained by mixing a raw pellet of a polylactic acid resin of 100% by weight and a functional agent pellet of PE-SROPE (Registered Trade Mark) at a weight ratio of 9:1.

### Comparative Example 3

A filament in Comparative Example 2 is a filament manufactured by extruding a functional raw pellet obtained by mixing a raw pellet of a polylactic acid resin of 100% by weight and a functional agent pellet of PP-SROPE (Registered Trade Mark) at a weight ratio of 9:1.

### Example 1

Example 1 is a filament manufactured by extruding a raw pellet obtained by mixing a polylactic acid resin of 60% by weight and an olefinic elastomer of 40% by weight (containing a mineral-oil-based plasticizer of 60% by weight).

### Example 2

Example 2 is a filament manufactured by extruding a raw pellet obtained by mixing a polylactic acid resin of 50% by weight and a styrene elastomer of 50% by weight (containing a mineral-oil-based plasticizer of 70% by weight).

### Example 3

Example 3 is a filament manufactured by extruding a functional raw pellet obtained by mixing a raw pellet obtained by mixing a polylactic acid resin of 50% by weight and a styrene elastomer of 50% by weight (containing a mineral-oil-based plasticizer of 70% by weight) and PE-SROPE (Registered Trade Mark) at a weight ratio of 9:1.

### Example 4

A filament in Example 4 is a filament manufactured by extruding a functional raw pellet obtained by mixing a raw pellet obtained by mixing a polylactic acid resin of 60% by weight and a styrene elastomer of 40% by weight (containing a mineral-oil-based plasticizer of 70% by weight) and PP-SROPE (Registered Trade Mark) at a weight ratio of 9:1.

### Example 5

A filament in Example 5 is a filament manufactured by extruding a functional raw pellet obtained by mixing a raw pellet obtained by mixing a polylactic acid resin of 60% by weight and olefinic elastomer of 40% by weight (containing a mineral-oil-based plasticizer of 60% by weight) and PP-SROPE (Registered Trade Mark) at a weight ratio of 9:1.

### Example 6

A filament in Example 6 is a filament manufactured by extruding a functional raw pellet obtained by mixing a raw pellet obtained by mixing a polylactic acid resin of 30% by weight and olefinic elastomer of 70% by weight (containing a mineral-oil-based plasticizer of 60% by weight) and PP-SROPE (Registered Trade Mark) at a weight ratio of 9:1.

### Example 7

A filament in [Example 7] is a filament manufactured by extruding a functional raw pellet obtained by mixing a raw pellet obtained by mixing a polylactic acid resin of 40% by weight and olefinic elastomer of 60% by weight (containing a mineral-oil-based plasticizer of 60% by weight) and PP-SROPE (Registered Trade Mark) at a weight ratio of 8:2.

### Example 8

A filament in [Example 8] is a filament manufactured by extruding a functional raw pellet obtained by mixing a raw pellet obtained by mixing a polylactic acid resin of 40% by weight and styrene elastomer of 60% by weight (containing a mineral-oil-based plasticizer of 70% by weight) and PE-SROPE (Registered Trade Mark) at a weight ratio of 9:1.

### Example 9

A filament in [Example 9] is a filament manufactured by extruding a functional raw pellet obtained by mixing a raw pellet obtained by mixing a polylactic acid resin of 30% by weight and styrene elastomer of 70% by weight (containing a mineral-oil-based plasticizer of 70% by weight) and PE-SROPE (Registered Trade Mark) at a weight ratio of 8:2.

### Example 10

A filament in [Example 10] is a filament manufactured by extruding a functional raw pellet obtained by mixing a raw pellet obtained by mixing a polylactic acid resin of 85% by weight and olefinic elastomer of 15% by weight (containing a mineral-oil-based plasticizer of 40% by weight) and PP-SROPE (Registered Trade Mark) at a weight ratio of 9:1.

### <Section Roundness Measurement>

With respect to the filaments in Examples 1 to 10 and Comparative Examples 1 to 3, the roundnesses of the sectional shapes were measured. The measurement was performed by using a measurement device (LDM-303H-XY, non-contact laser scanning scheme) available from Takikawa Engineering Co., Ltd. A measurement accuracy is ±2 μm, and a resolution is 0.1 μm.

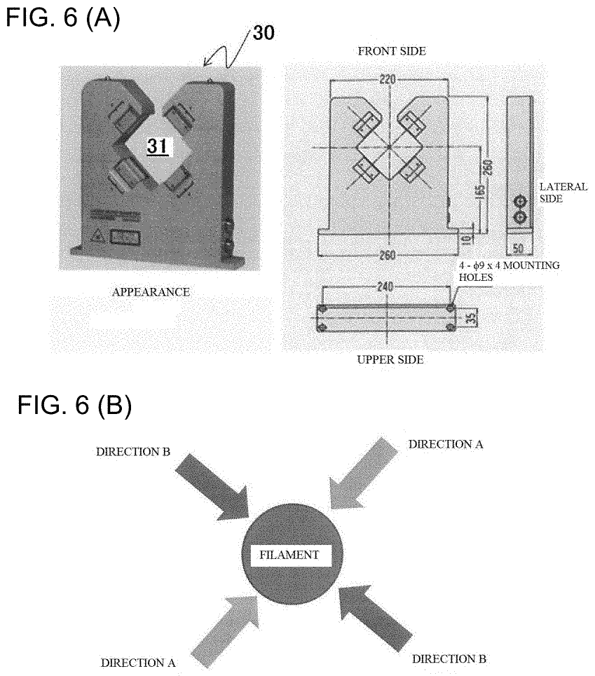

FIGS. 6A and 6B are explanatory diagrams of a section roundness measurement for a filament, in which FIG. 6A shows a measurement device and FIG. 6B shows a measurement method.

The measurement is performed such that the filaments in Examples 1 to 10 and Comparative Examples 1 to 3 are inserted into a central portion 11 of a measurement device 30 shown in FIG. 6A and conveyed and a laser is irradiated on the surfaces of the filaments.

The section roundness can be measured such that the diameter of the filament in two directions, i.e., a direction A and a direction B shown in FIG. 6B and a fluctuations in diameter in the direction A (to be referred to as an A-direction diameter), a fluctuation in diameter in the direction B (to be referred to as a B-direction diameter), and a fluctuation in average (A- and B-direction average diameter) of the A-direction diameter and the B-direction diameter are measured.

When the difference between the A-direction diameter and the B-direction diameter increases, the filament is largely out-of-round. In addition, in the section roundness measurement, when the filament is rotated in a direction orthogonal to the conveying direction of a measurement unit 31, the A-direction diameter and the B-direction diameter can be measured at different positions in the circumferential direction of the filament.

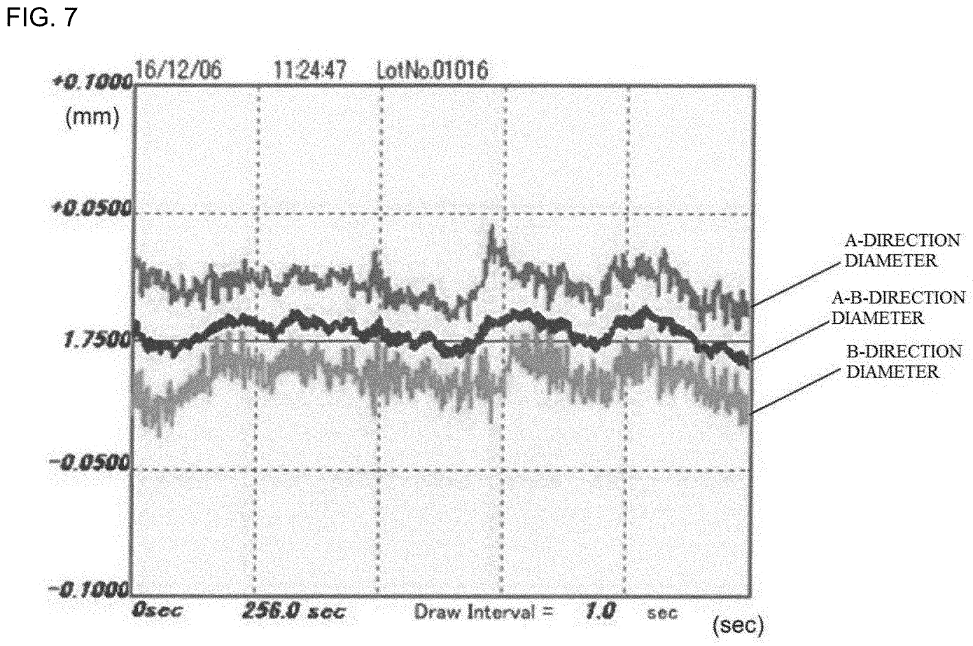

FIG. 7 to FIG. 19 are diagrams showing results of the section roundness measurements of the filaments according to the embodiment, and are obtained by acquiring and graphing the A-direction diameters and the B-direction diameters at one second intervals (Draw Interval=1.0 second). The abscissa of each of the drawings indicates elapsed time (second) from the start of the section roundness measurement of the filament conveyed in the measurement unit 31, and the ordinate of each of the drawings indicates the diameter (millimeter) of the filament which is a measurement result.

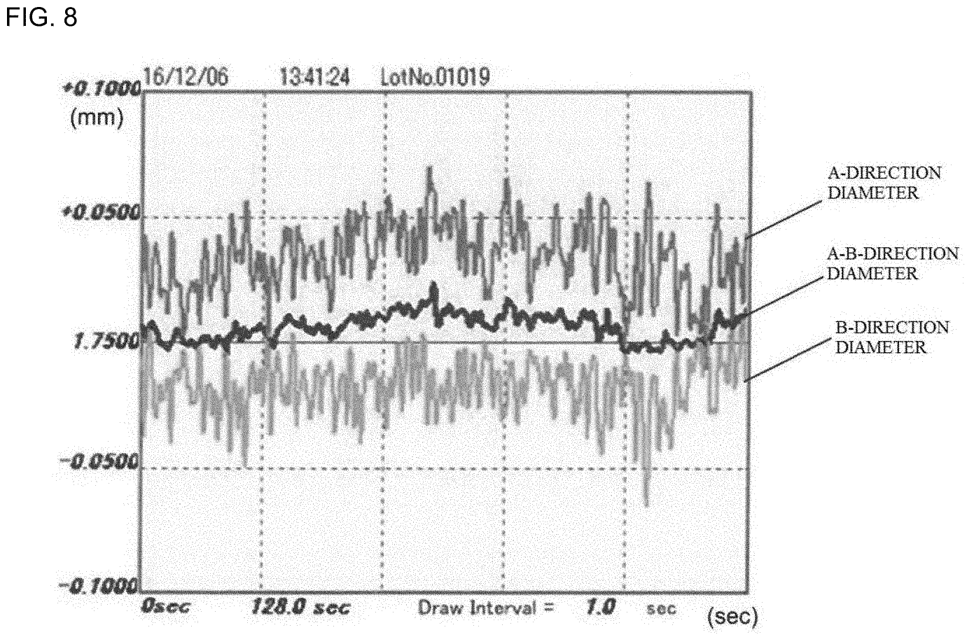

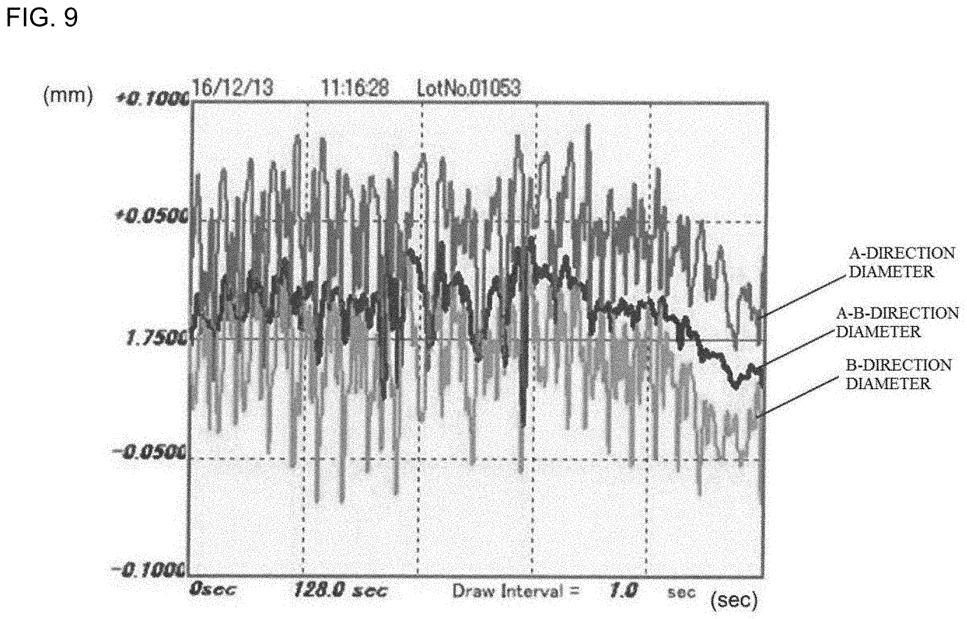

In the filaments in Comparative Example 1 (FIG. 7), Comparative Example 2 (FIG. 8), and Comparative Example 3 (FIG. 9), the differences between the A-direction diameters and the B-direction diameters are about 0.05 mm to 0.1 mm.

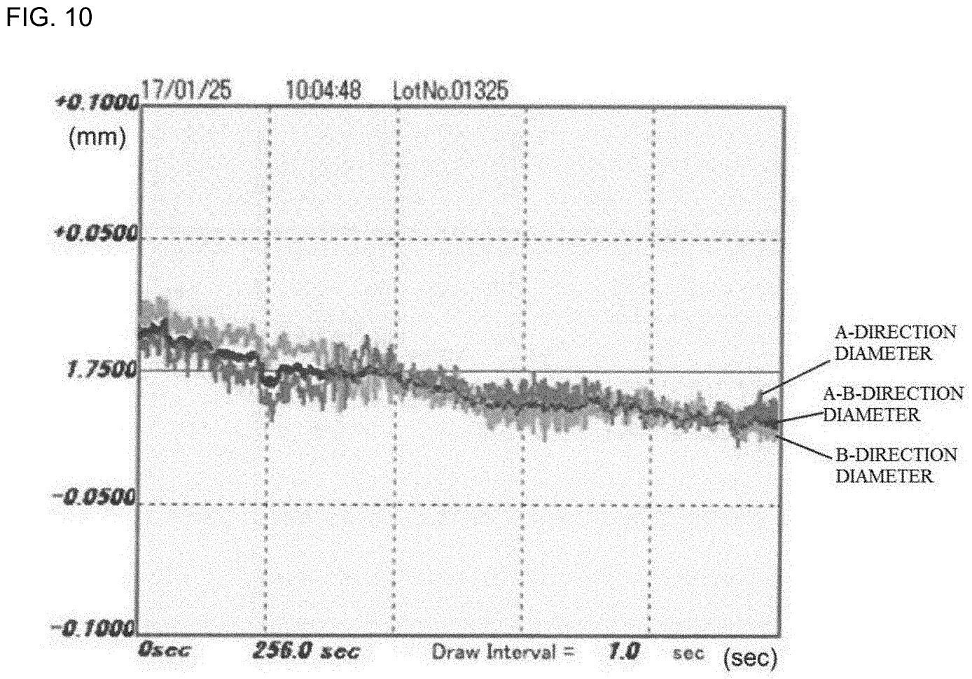

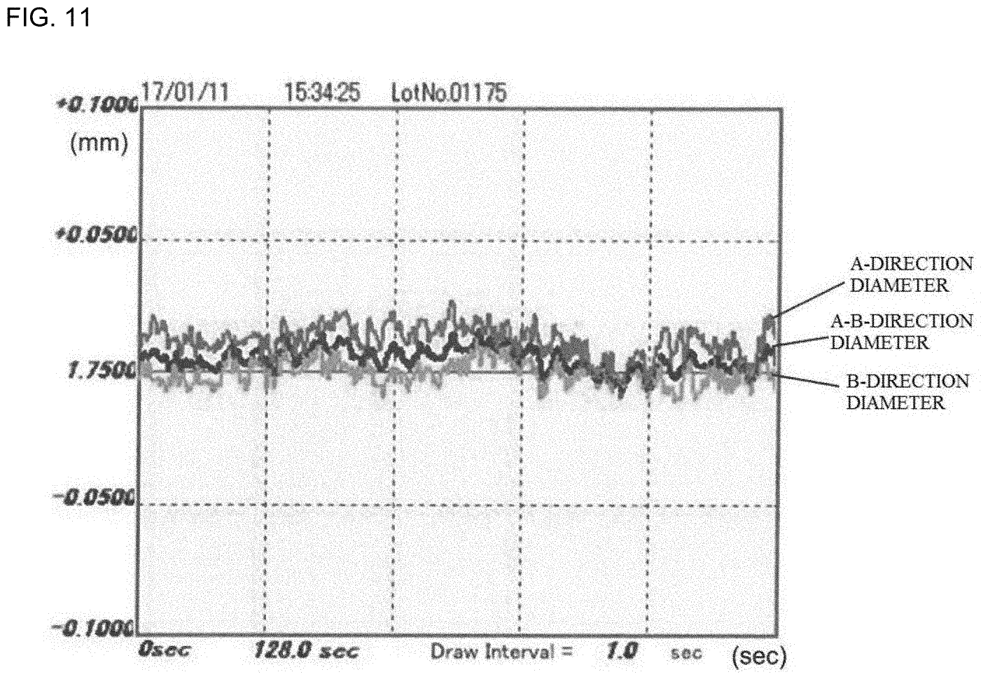

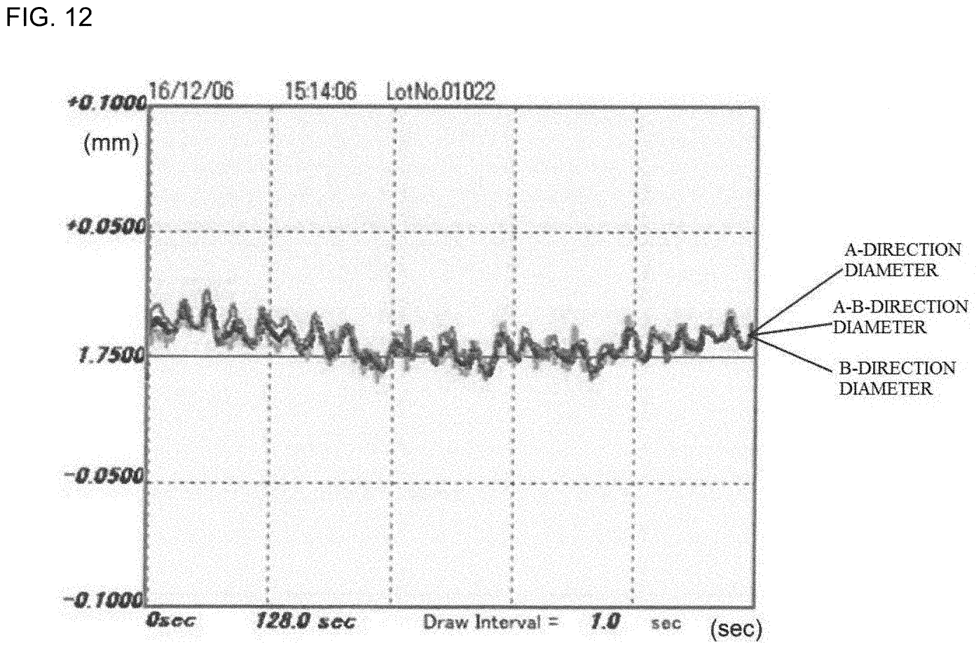

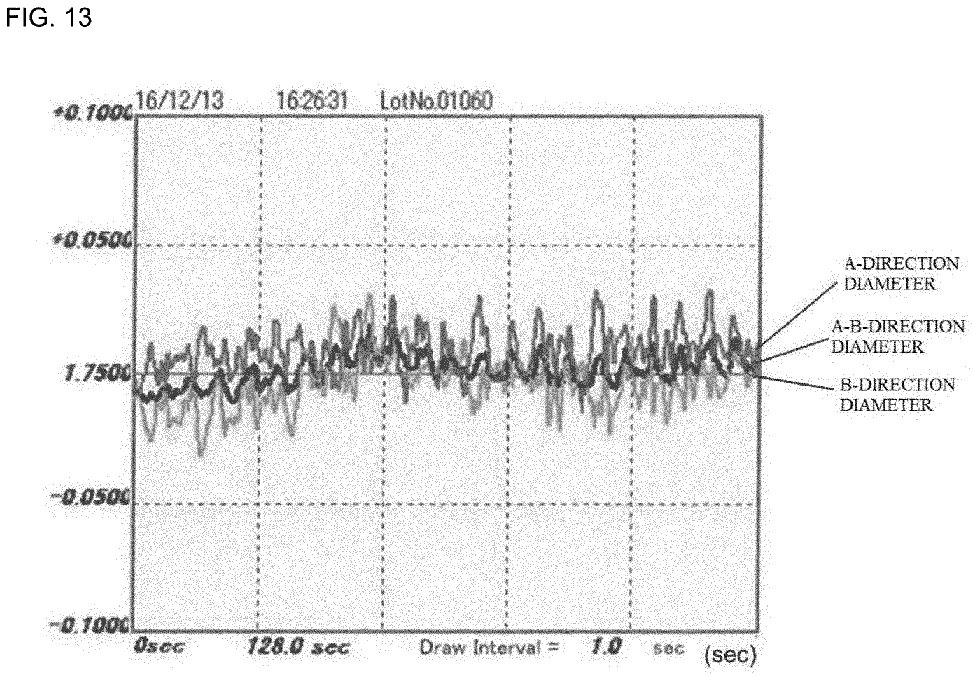

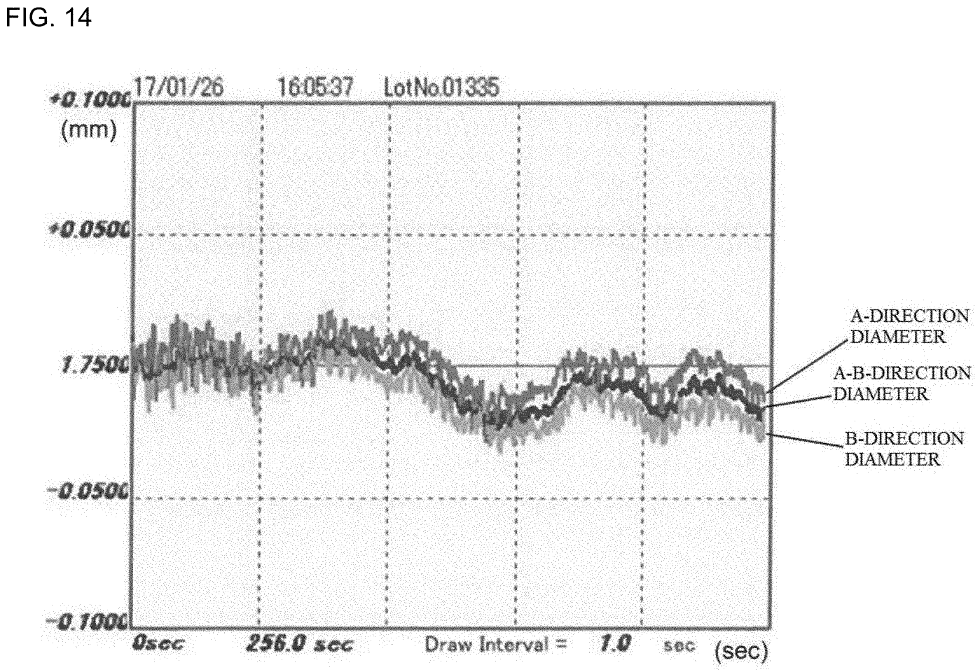

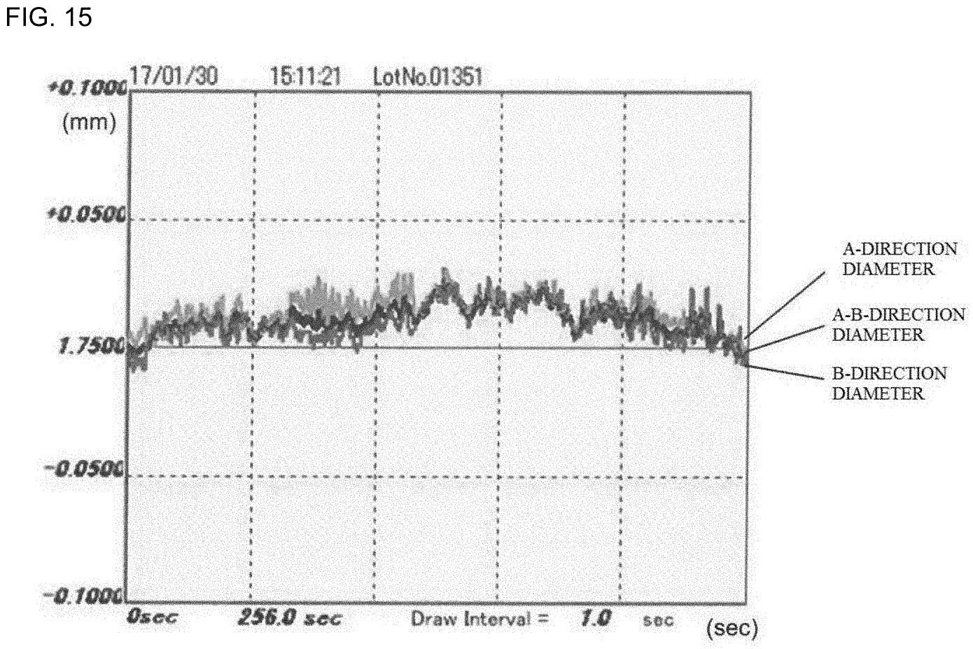

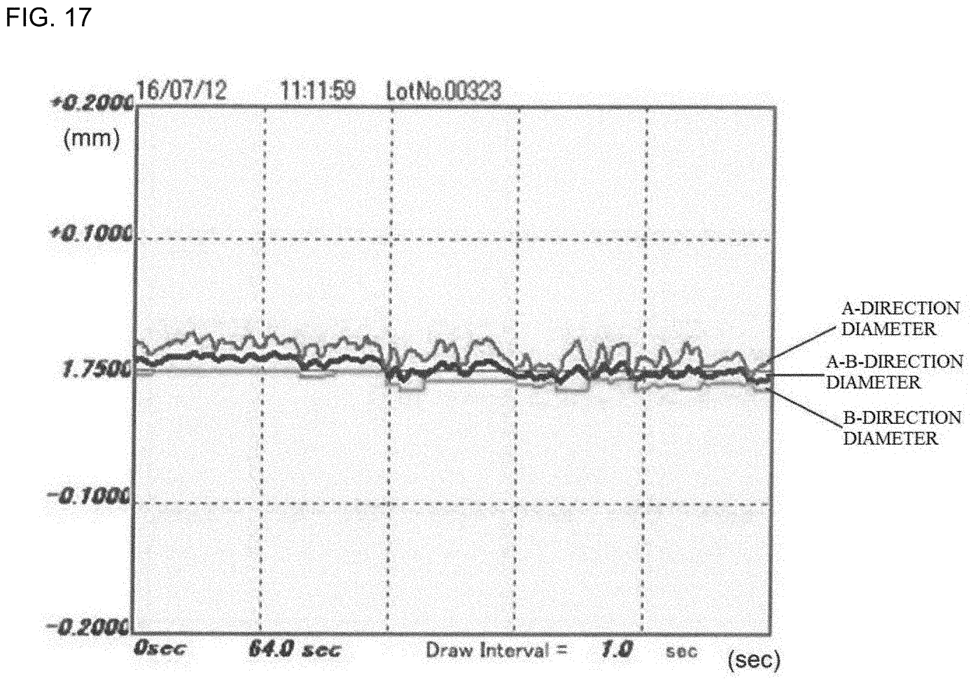

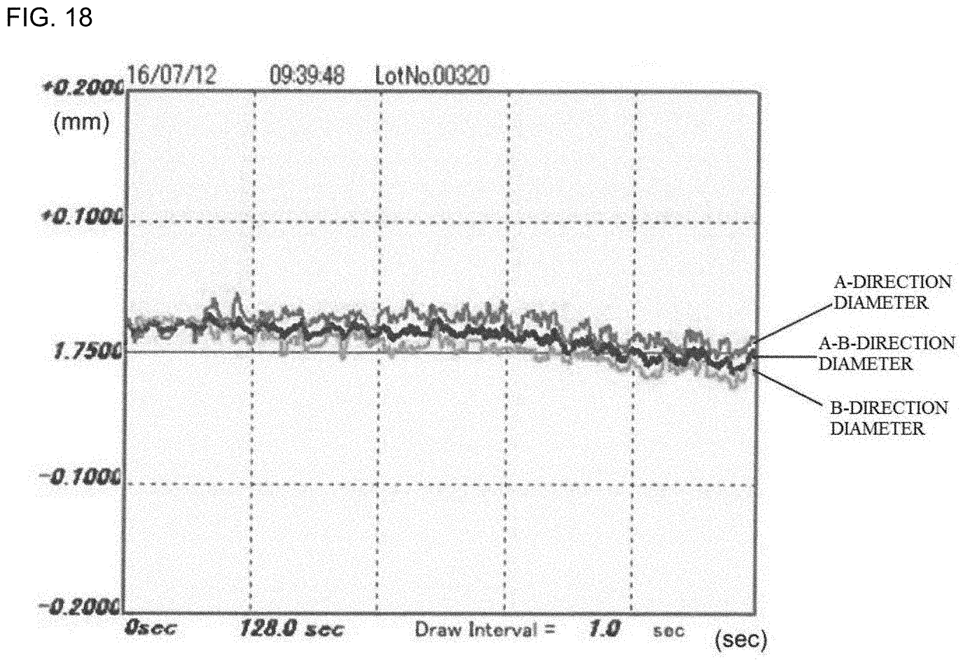

In the filaments in Comparative Example 1 (FIG. 10), Example 2 (FIG. 11), Example 3 (FIG. 12), Example 4 (FIG. 13), Example 5 (FIG. 14), Example 6 (FIG. 15), Example 8 (FIG. 17), and Example 9 (FIG. 18), differences between the A-direction diameters and the B-direction diameters are smaller than 0.05 mm to 0.1 mm, and the section roundnesses are preferable more than those of the filaments in Comparative Example 1 (FIG. 7) to Comparative Examples 3 (FIG. 9). In particular, the section roundness of the filament in Example 3 (FIG. 12) is preferable.

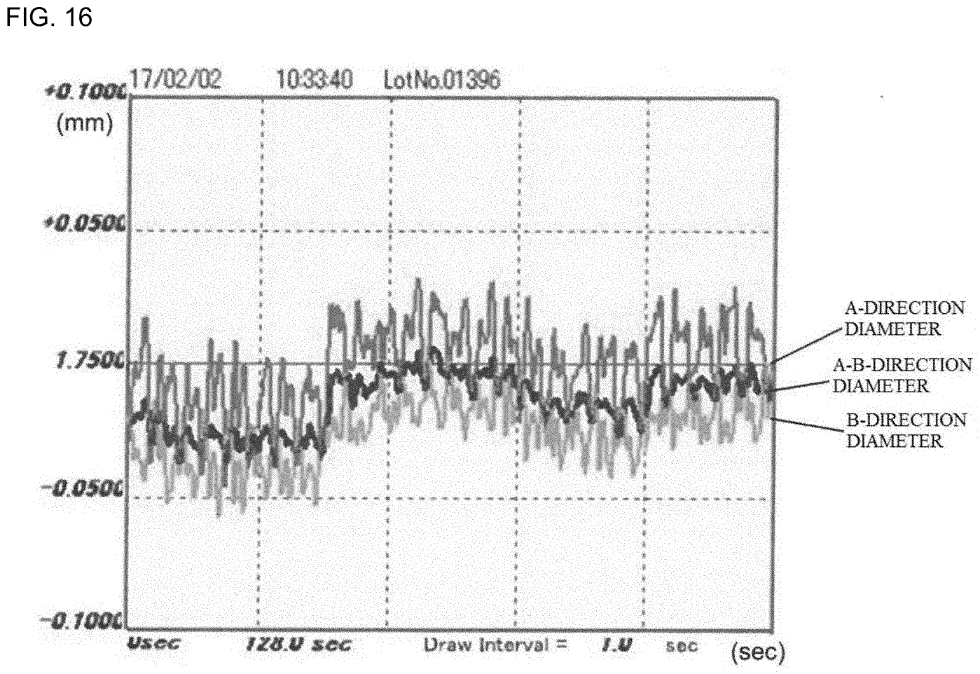

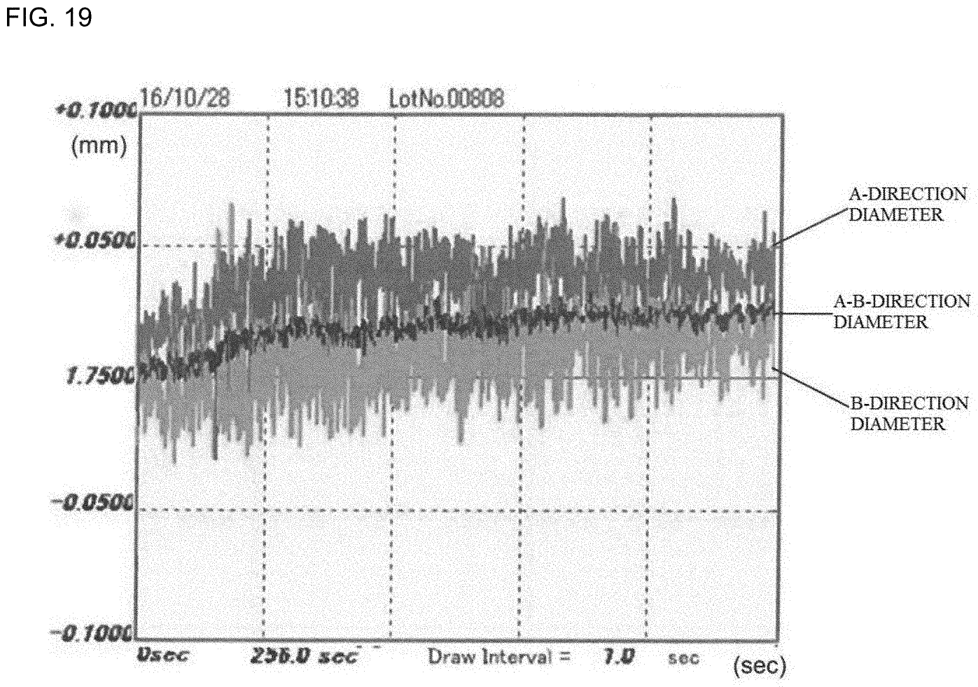

The roundnesses of the filaments in Example 7 (FIG. 16) and Example 10 (FIG. 19) are preferably more than those in Comparative Example 1 to Comparative Example 3 when averages of fluctuations in section roundness are compared with each other.

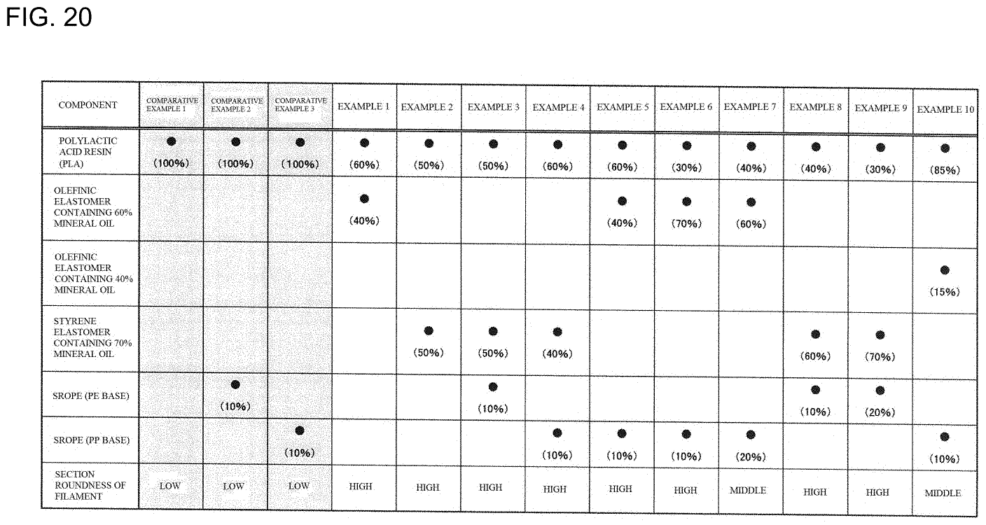

FIG. 20 is a diagram obtained by collecting results of the section roundnesses of the filaments according to Comparative Example 1 to Comparative Example 3 and Example 1 to Example 10.

Example 7 (FIG. 16) has a low section roundness. The filament in Example 7 uses a raw pellet obtained by mixing a polylactic acid resin of 40% by weight and an olefinic elastomer of 60% by weight (containing a mineral-oil-based plasticizer of 60% by weight).

Both the weight ratios of the polylactic acid resin and the olefinic elastomer are intermediate values between the values in Example 5 (FIG. 14) and Example 6 (FIG. 15). However, the section roundnesses of the filaments in Example 5 (FIG. 14) and Example 6 (FIG. 15) are high.

Thus, the reason why the section roundness of the filament in Example 7 may be a mixing ratio of PP-SROPE (Registered Trade Mark) (functional pellet) to the mixture (raw pellet) of the polylactic acid resin and the olefinic elastomer. More specifically, in terms of the section roundness of the filament, the upper limit of the functional pellet (for example, PP-SROPE (Registered Trade Mark)) which can be mixed with the raw pellet is 20% by weight.

The section roundness of the filament in Example 10 is low. As the configuration of the raw pellet, the ratio of the polylactic acid resin is preferably set to a ratio lower than 85% by weight.

### <Advantages>

The filament according to the embodiment is used in a three-dimensional printing device which uses a fused deposition modeling method (FDM) to perform three-dimensional molding, serves as a raw material of a three-dimensional molded object, contains a polylactic acid resin and a thermoplastic elastomer at an arbitrary ratio ranging from 85% by weight:15% by weight to 1% by weight:99% by weight, and corresponds to, for example, Example 1 (FIG. 10) to Example 6 (FIG. 15), Example 8 (FIG. 17), and Example 9 (FIG. 18).

In this manner, when the filament contains the polylactic acid and the thermoplastic elastomer at a predetermined ratio, the filament has a sectional shape which is uniform more than that of a filament made of, for example, polylactic acid.

More specifically, the sectional shape of the filament can be approximated to a perfect circle, and nipping force acting on a contact point between the filament and the roller nipping and feeding the filament in the three-dimensional printing device becomes stable to reduce defective conveyance.

In addition, since the defective conveyance of the filament is reduced, uneven discharging from the nozzle of the head part reduces to make it possible to improve reproducing accuracy of three-dimensional drawing data imported on a computer.

When polylactic acid and a thermoplastic elastomer are combined to each other at the weight ratio described above, for example, a filament having a sectional shape which can be easily approximated to a perfect circle even though the filament contains a functional agent such as SROPE (Registered Trade Mark) can be achieved.

More specifically, a filament which can be preferably fed in the three-dimensional printing device and can give a function except for a shape to a three-dimensional molded object can be provided.

Since a filament contains the polylactic acid resin and the olefinic resin at an arbitrary ratio ranging from 60% by weight:40% by weight to 30% by weight:70% by weight or the polylactic acid resin and the styrene resin at an arbitrary ratio ranging from 60% by weight:40% by weight to 30% by weight:70% by weight, as described in the results of the section roundness measurement, the advantages can be easily and reliably achieved.

Since the thermoplastic elastomer contains a mineral-oil-based plasticizer at an arbitrary ratio ranging from 60% by weight to 70% by weight, as described in the results of the section roundness measurement, the advantages can be easily and reliably achieved.

Since the mixture of the polylactic acid resin and the thermoplastic elastomer is mixed with SROPE (Registered Trade Mark) serving as a functional agent giving characteristics except for a shape to a three-dimensional molded object, the characteristics except for the shape can be given to the three-dimensional molded object, and the use value of the three-dimensional molded object increases.

Since SROPE (Registered Trade Mark) is mixed at an arbitrary ratio ranging from 20% by weight or less, the sectional shape of the filament can be easily approximated to a perfect circle, and characteristics except for the shape can be given to a three-dimensional molded object.

Since SROPE (Registered Trade Mark) contains an active constituent existing as an emulsion structure, the active constituent is emitted moderately more than a functional agent which does not an active constituent as an emulsion structure.

Since the functional agent includes at least one of botanical essential oil, lubricant, aromatic ester, and paraben, an effect such as aroma, dust proof, insect proof, mildew proof, or antibacterial activity to a three-dimensional molded object.

The filament according to the present invention has been described above, changes, addition, and the like of the invention are permitted without departing from the spirit and scope of the invention described in claims.

For example, although an example using SROPE (Registered Trade Mark) as a functional agent has been described, not only SROPE (Registered Trade Mark) but also a functional agent containing a polylactic acid resin and a thermoplastic elastomer at a ratio ranging from 85% by weight:15% by weight to 1% by weight:99% by weight can be used. A functional agent containing an active constituent as an emulsion structure, especially, SROPE (Registered Trade Mark) is preferably used as a filament.

### INDUSTRIAL APPLICABILITY

A filament and a method of manufacturing the filament according to the present invention can be popularly used as a filament used as a raw material of a printed matter printed by a three-dimensional printing device using a fused deposition modeling method (FDM).

### REFERENCE NUMERALS

103: head part of three-dimensional printing device
11: roller
11a: rotating direction of roller
11b: regulating force of roller
12: drive gear
12a: rotating direction of drive gear
12b: regulating force of drive gear
13: heater part
14: nozzle part
21: important region of filament
22: projection direction after filament is fused
30: measurement device
31: measurement unit of measurement device

1. A filament which is used as a material of a printed matter printed by a three-dimensional printing device using a fused deposition modeling method (FDM), containing
a polylactic acid resin and a thermoplastic elastomer.

2. The filament according to claim 1, wherein the thermoplastic elastomer contains a styrene resin and a mineral-oil-based plasticizer.

3. The filament according to claim 1, wherein the thermoplastic elastomer contains an olefinic resin and a mineral-oil-based plasticizer.

4. The filament according to claim 1, wherein the thermoplastic elastomer contains an olefinic resin and a mineral-oil-based plasticizer at an arbitrary ratio ranging from a mixing weight ratio of 50:50 to a mixing weight ratio of 60:40.

5. The filament according to claim 1, wherein the filament contains the polylactic acid resin and the thermoplastic elastomer at an arbitrary ratio ranging from 10 parts by weight:1 part by weight to 1 part by weight:10 parts by weight.

6. A method of manufacturing a filament used as a material of a printed matter printed by a three-dimensional printing device using a fused deposition modeling method (FDM) wherein
a total of 100% by weight of a polylactic acid resin and a thermoplastic elastomer are mixed and fused by heating to manufacture a filament by extrusion.

7. The method of manufacturing a filament according to claim 6, wherein the thermoplastic elastomer contains a styrene resin and a mineral-oil-based plasticizer.

8. The method of manufacturing a filament according to claim 6, wherein the thermoplastic elastomer contains an olefinic resin and a mineral-oil-based plasticizer.

9. A method of manufacturing a filament used as a material of a printed matter printed by a three-dimensional printing device using a fused deposition modeling method (FDM) comprising:
the mixing step of mixing a polylactic acid resin and a thermoplastic elastomer with each other to produce a mixture; and
the molding step of molding the obtained mixture into a filament by extrusion.

10. The method of manufacturing a filament according to claim 9 comprising, before the mixing step, the thermoplastic elastomer producing step of adjusting a mixing weight ratio of an olefinic resin and a mineral-oil-based plasticizer to a ratio ranging from 50:50 to 60:40 to produce a thermoplastic elastomer.

11. The method of manufacturing a filament according to claim 9, wherein, in the mixing step, the polylactic acid resin and the thermoplastic elastomer are mixed with each other at a ratio ranging from 10 parts by weight:1 part by weight to 1 part by weight to 10 parts by weight.

12. A filament used in a three-dimensional printing device performing three-dimensional molding by using a fused deposition modeling method (FDM) and serving as a material of a three-dimensional molded object, wherein
the filament contains a polylactic acid resin and a thermoplastic elastomer at an arbitrary ratio ranging from 85% by weight:15% by weight to 1% by weight:99% by weight.

13. The filament according to claim 12, wherein the filament contains the polylactic acid resin and the olefinic resin at an arbitrary ratio ranging from 60% by weight:40% by weight to 30% by weight:70% by weight.

14. The filament according to claim 12, wherein the filament contains the polylactic acid resin and the styrene resin at an arbitrary ratio ranging from 60% by weight:40% by weight to 30% by weight:70% by weight.

15. The filament according to claim 12, wherein the thermoplastic elastomer contains a mineral-oil-based plasticizer at a ratio of 40% by weight to 70% by weight.

16. The filament according to claim 12, wherein the filament is obtained by mixing a mixture of the polylactic acid resin and the thermoplastic elastomer with a functional agent giving characteristics other than a shape to the three-dimensional molded object.

17. The filament according to claim 16, wherein the functional agent is mixed at an ratio ranging from 20% by weight or less.

18. The filament according to claim 16, wherein the functional agent includes at least one of botanical essential oil, lubricant, aromatic ester, and paraben.
